(19) United States
(12) Patent Application Publication
(10) Pub. No.: US 2020/0293960 A1
(43) Pub. Date: Sep. 17, 2020

(54) SYSTEM FOR SIMULATING COMMODITIES AND EMULATING DISRUPTIONS IN DOMAIN NETWORKS

(71) Applicant: The Board of Trustees of the University of Illinois, Urbana, IL (US)

(72) Inventors: Gabriel A. Weaver, Urbana, IL (US); Lavanya Marla, Urbana, IL (US); Randall Sandone, Urbana, IL (US); Glen Salo, Urbana, IL (US)

(21) Appl. No.: 16/813,884

(22) Filed: Mar. 10, 2020

Related U.S. Application Data
(60) Provisional application No. 62/817,655, filed on Mar. 13, 2019.

(51) Int. Cl. G06Q 10/06; G06Q 10/04; G06Q 10/08

(52) U.S. Cl. CPC G06Q 10/0635; G06Q 10/0637; G06Q 10/087; G06Q 10/04

(57) ABSTRACT

A system for simulation of network flow in a first domain network based on emulation of disruptions in a second domain network includes a simulation engine configured to model the network flow of the first domain network, where the network flow model is based on a plurality of resources available in a first subject area corresponding to first domain network. Also included is an emulation engine configured to emulate the second domain network, where the second domain network has a plurality of resources available in a second subject area. A disruption corresponding to at least one resource in the second domain network is provided to the emulation engine, which utilizes the disruption to model the network flow of the resources in the second domain network so that the disruption in the second domain network is reflected in the network flow model of the first domain network.

### RELATED APPLICATIONS

This application claims priority to U.S. provisional application Ser. No. 62/817,655, filed on Mar. 13, 2019, the contents of which are incorporated herein in its entirety.

### GOVERNMENT LICENSE RIGHTS

This invention was made with government support under grant award number DHS 2015-ST-061-CIRC01 awarded by the U.S. Department of Homeland Security. The government has certain rights in the invention.

### FIELD OF THE DISCLOSURE

This disclosure relates to simulators and optimizers and in particular, to a risk evaluation system and method configured to iteratively model the flow of commodities across network layers that represent critical infrastructure sectors and schedule optimal mitigations, disruptions, or responses in order to understand their impact within and across these network layers.

### BACKGROUND

Modern civilization depends upon critical infrastructure systems in order to function properly. The United States Federal Government classifies critical infrastructure systems according to 16 different sectors that include the Energy Sector, Transportation Sector, and Communications and IT Sectors to name a few. Interdependencies across systems within these sectors mean that the correct operation of a system may depend on any number of systems within other sectors. Therefore, there is need for a simulation system or risk assessment tool to document these interdependencies and understand their consequences in terms of the function of the system and individual components.

Shipping ports are a nexus of critical infrastructure. Within a small geographic region, there are interactions between the transportation, communications/IT, and energy sectors. As such, shipping ports are well suited to develop a cross-infrastructure simulation system or risk analysis tool.

Modern shipping ports require computer systems to accommodate an increasing number of port calls, larger vessel sizes, and tighter supply chains. Disruptions to assets or resources on these transportation networks (whether direct or indirect) have the potential to propagate to other critical infrastructures at great economic cost.

The integration of automation and security networks into shipping port operations motivates the need to model disruptions that cover all-hazards facing the Maritime Transportation System (MTS). Certain events, such as Hurricane Harvey as well as the NotPetya ransomware attack highlight the variety of hazards faced by the MTS. Area Maritime Security Committees (AMSCs) need to develop security plans to minimize the impact of disruptions.

Researchers and practitioners—in order to understand the impact of disruptions, as well as mitigation and response strategies—need a better understanding of the interactions between and dependencies among critical infrastructure sectors. For example, lack of understanding of cyber-physical dependencies between the MTS and the Communications/IT Sector may lead to increased risk of attack. “The massive growth of networked and connected devices also increases the attack surface, enable cyber physical effects, and impacts overall security costs. This is due in large part to an increased number of connected devices, a lack of emphasis on security, and little awareness of what is actually connected.” (DiRenzo, Drumhiller, and Roberts 2017). Cyber-originating disruptions may be introduced intentionally by adversaries that include nation states, organized crime, hacktivists, and insiders.

The variety and combination of these disruptions, across a variety of critical infrastructure systems, motivates the need for stakeholders to understand the impact of disruptions as well as mitigation and response/recovery strategies. The simulation system or risk assessment tool described in specific embodiments this disclosure address these needs.

### SUMMARY

This document discloses some embodiments that couple a simulation of the flow of commodities through a shipping port with an optimization that minimizes the impact (e.g., economic cost) of disruptions to the maritime transportation system. Some embodiments of the present invention are directed to modeling the flow of commodities across networks that represent critical infrastructure sectors. Interdependencies among these sectors enable flows in one network layer to affect flows in another network layer. The optimizer-simulator may be used to schedule mitigations, disruptions, or responses in order to understand their impact within and across network layers that represent critical infrastructure sectors. Within this broader context, this disclosure provides details about simulation and optimization of the flow of commodities through a transportation network at a shipping port under normal operations and how to evaluate mitigation or response actions given one or more disruptions in the resources that facilitate the flow of the commodities through the network.

This may enable stakeholders to run “what-if” scenarios, to understand the impact and effect of cross-infrastructure disruptions, and to optimally mitigate, respond to, and recover from their effect. This may improve security policies that integrate a variety of threat models across different critical infrastructure sectors.

Integrating an optimizer or optimization engine with a simulator or simulation engine provides a clean separation of concerns. The simulator enables one to understand the movement of containers through the system while accounting for resource usage, such as percentage of servers used at any one point in time or the number of trucks queued (including spillover). In contrast, known optimizers cannot compute the resource utilization at any point in time, rather only that they are used within a given set of constraints.

The optimizer, however, can compute the optimal route and schedule by which goods should be routed within capacity and time constraints. As such, it is desirable to integrate an optimization engine with a simulation engine to provide a way to get the benefits of optimal routing as resource availability evolves within the simulation due to increased traffic flows, disruptions, or even mitigation or response actions. Such novel tools are useful for developing mitigation and response plans in terms of quantifiable, capability targets as defined within Department of Homeland Security (DHS) Threat and Hazard Identification and Risk Assessment (THIRA framework).

According to one embodiment, a simulation system or risk evaluation tool is configured to model a flow of a plurality of commodities through a shipping port. The simulation system or risk evaluation tool includes a user interface configured to create a network flow model of a commodities transportation network associated with a shipping port, where the network flow model is based on a plurality of resources available to the shipping port, and where the plurality of resources facilitate a flow of the plurality of commodities through the commodities transportation network.

A simulation engine is in communication with the user interface (UI) and is configured to simulate the plurality of the commodities flowing through the commodities transportation network, based on the network flow model. The simulation engine plays the role of an indicator of ongoing and upcoming congestion or choke points in traffic flow. An optimization engine is in operative communication with the simulation engine (and UI), and is configured to evaluate and minimize an impact of one or more disruptions to one or more of the plurality of resources.

Further, a plurality of threat descriptions is selectable through the user interface, where one or more of the selected threats is provided to the simulation engine to represent disruption(s) to one or more of the plurality of resources. An output engine provides a visual representation of the plurality of commodities flowing through the commodities transportation network and generates reports selectable through the user interface.

In a further embodiment, a system for simulation of network flow in a first domain network based on emulation of disruptions in a second domain network includes a simulation engine configured to generate a network flow model of the first domain network, where the network flow model is based on a plurality of resources available in a first subject area corresponding to first domain network. Also included is an emulation engine configured to emulate the second domain network, where the second domain network has a plurality of resources available in a second subject area. A disruption corresponding to at least one resource in the second domain network is provided to the emulation engine, which utilizes the disruption to model the network flow of the resources in the second domain network so that the disruption in the second domain network is reflected in the network flow model of the first domain network. An output engine provides a representation of the network flow through the first domain network as a result of the disruption in the second domain network.

In yet another embodiment, a method for simulation of network flow in a first domain network based on emulation of disruption in a second domain network, includes simulating, using a simulation engine, a network flow to generate a model of the first domain network, where the network flow model is based on a plurality of resources available in a first subject area corresponding to first domain network. The method further includes emulating, using an emulation engine, the second domain network, where the second domain network has a plurality of resources available in a second subject area. A disruption is provided to the emulation engine, which disruption corresponds to at least one resource in the second domain network. The emulation engine utilizes the disruption to model the network flow of the resources in the second domain network. The disruption in the second domain network is reflected in the network flow model of the first domain network. An output engine outputs a representation of the network flow through the first domain network as a result of the disruption in the second domain network.

Embodiments of the invention described in this document provide certain technical solutions to technical problems not found in known systems or models. Several exemplary technical problems are described below, along with their corresponding technical solutions and real-world scenarios.

Technical Problem 1: A first such technical problem involves the ability to anticipate and respond to issues in commodity flows, such as in a shipping port or other domain (cyber-physical domain, power domain, transportation domain, and the like). Existing systems and models are very limited and do not explicitly model other critical infrastructure layers, such as between different domains, or relate their performance between domains. In other words, for example, known systems and models do not model the cyber-physical domain relative to that of the transportation layer, nor quantify the impact of disruptions between the layers. However, embodiments of the subject invention provide significant improvements over known systems and models by providing access to data, providing the ability to simulate data usage, and providing the ability to play ahead in other domains (e.g. between the transportation domain and the cyber domain, for example). In that regard, the ability to play ahead means that commodity flow problems can be identified, regardless of the affected domain.

The ability to identify commodity flow problems is a distinct improvement over known systems and models because such improvements provide 1) the ability to determine a solution to the problem, where such a solution may include rescheduling or rerouting resources, for example, in the transportation domain; 2) the ability to compute economic impact with economic and concrete data and 3) the ability to spin-up or facilitate additional monitoring in other critical infrastructure domains. Such improvements described in the embodiments of the invention also include improvements in the simulation process due to feedback, including but not limited to use reinforcement learning. Such technical solutions to technical problems described above may utilize observed and/or measured data, combined with simulation and/or emulation of multilayered networks (e.g., transportation, cyber, power) to identify and respond to commodity flow problems or disruptions. This certainly cannot be performed by humans.

Technical Problem 2: A second such technical problem involves the need to translate measures of performance across infrastructure layers. Existing systems and models are very limited and do not explicitly translate measures of performance of an source infrastructure layer to a measure of performance on a dependent infrastructure layer. However, embodiments of the subject invention provide significant technical improvements over known systems and models by 1) explicitly simulating or emulating critical infrastructure sector models upon which the transportation system (or other domain or layer) depends; 2) providing that the source network (for example in the cyber or cyber-physical domain) be stochastic with respect to sampling the value of a measure of performance (observation/emulation); 3) providing that the measure of performance in the source network is a random variable described via a distribution obtained through sampling; and 4) providing that the measure of performance on the dependent infrastructure is a function of the above-mentioned random variable, and thus is also obtained via a sampling process. The above-described technical solutions requires computation to sample the measures of performance across the infrastructure, which known systems and models do not do.

Technical Problem 3: A third such technical problem involves the need track cross-infrastructure and cross-organizational interdependencies and respond to events in such a complex system. Known systems and models do not do this, and certainly the human mind cannot remotely begin to process information on this level. Existing systems and models are very limited and typically use a siloed and ad-hoc approach within critical infrastructure sectors. Such known systems and models do not explicitly model the social layer or data source layer or measure/identify how such layers relate to the critical infrastructure assets.

However, embodiments of the subject invention provide significant technical improvements over known systems and models by 1) integrating heterogeneous data sources (including social network data, camera feeds, sensor data from the physical domain, for example) across such a system (e.g. ontology); 2) explicitly representing a corpus of data sources used to support socio-technical analysis of infrastructure; and 3) simulating cross-infrastructure disruptions that affect transportation network as well as who is involved socially, for example when dealing with the transportation domain. The above-described technical solution of this example requires organizing information so that a stakeholder can seamlessly pivot across stakeholders' infrastructure and organizational structure. In known systems and models, no such organizational map exists.

Real World Examples for Technical Problem 1: Cyber to Transportation Domain

### Example 1

Port Everglades' vessel call data contained an error in which two vessels were booked at the same berth during overlapping time slots. If the ability to play forward had been available for the transportation network based on vessel calls data (from cyber model database), personnel could have identified the double-booking problem before it happened and could have responded accordingly. However, known systems and models do not provide this ability.

### Example 2

The Port of Antwerp experienced a data integrity attack to their Terminal Operating System (TOS) in which organized criminals were able to edit TOS entries to reroute certain commodity flows. This went undetected for several years. If the facility had the ability to play forward the transportation network based on the TOS database, they may have been able to identify suspicious flows and respond accordingly. However, known systems and models do not provide this ability.

### Example 3

Port Everglades has experienced traffic congestion problems depending upon the timing of vessel arrivals and truck/rail arrivals. Such traffic congestion affects the ability to move goods and requires occasionally deploying law enforcement personnel to assist. If the facility had the ability to play forward the transportation network based on vessel schedules, rail schedules, and the like, they may have been able to anticipate congested days and alert law enforcement. However, known systems and models do not provide this ability.

### Example 4

Ransomware attacks are affecting ports and municipalities in general (e.g. Barcelona, San Diego, NotPetya, Ryuk). It is difficult to know the impact of a ransomware attack that affects the MTS. If MTS facilities had the ability to play forward the transportation system based on availability of data sources, they may be able to understand the impact to commodity flows. However, known systems and models do not provide this ability.

### Example 5

Automated systems depend upon TOS in order to know how to route goods, sometimes using autonomous vehicles. If TOS data is corrupted, personnel would want to know how this affects traffic flows of automated vehicles or vehicles that move according to data provided by TOS database If facilities had the ability to play forward the transportation network based on TOS data state, they may be able to determine the impact on container movements. However, known systems and models do not provide this ability.

### Example 6

Storm surge or a severed fiber optic cable may impact the availability of networked resources locally and/or remotely. Consider the fires in California in 2019 that affected availability of O'Reilly books online nationwide. The ability to play forward may have provided valuable information to the facility. However, known systems and models do not provide this ability.

Real World Examples for Technical Problem 1: Transportation to Cyber Domain

### Example 1

Developers of TOS may need to test their code and understand the impact of outputs as part of integration testing. If they had ability to play forward based on cyber code outputs, they may be able to test code based on impact to simulated port reference models. They could then flag issues in logic or process flow based on actual port reference models. However, known systems and models do not provide this ability.

### Example 2

Traffic patterns in the physical domain can drive traffic patterns in the Communications/IT domain. If relevant facilities had the ability to play forward based on transportation movements, such facilities could have a baseline for expected communications from a device affected by the transportation system movements (e.g. kiosk). Such a baseline could be used as input for IDS and to identify outliers based on the traffic expected for that week. However, known systems and models do not provide this ability.

Real World Examples for Technical Problem 1: Transportation to Cyber Domain and Cyber to Transportation Domain (Bidirectionally)

### Example 3

A container truck outfitted with an RF jammer could disrupt port operations. If the facility had the ability to play forward based on transportation movements, facility personnel could understand the impact of the jammer turning on and off on availability of system resources accessed via wireless communications in cyber domain. However, known systems and models do not provide this ability.

Real World Examples for Technical Problem 2: Cyber to Transportation Domain

### Example 1

The latency in a computer network may vary depending upon conditions (e.g. bandwidth, traffic, and the like). For example, the Customs and Border Protection database for inspection of containers may experience increased latency to access as more people from the West Coast go online due to time zone differences. The technical problem is to understand how network latency can affect commodity flows at ports. The technical solution provided by embodiments of this invention may sample latency via emulation or observation, for example, and use this distribution to compute service time at a location in the transportation network that depends upon this database. In the embodiments of this invention, many samples may be taken because latency is a random variable in the cyber network, which influences service time, which itself is a random variable in the transportation network. However, known systems and models do not provide this ability.

### Example 2

The jitter and packet loss in a computer network may vary based upon certain conditions. For example, a Denial of Service (DOS) attack could degrade network Quality of Service and make services like OCR (optical character recognition) and VOIP (voice over IP) used in ports, unusable. The technical problem is to understand how jitter and packet loss may affect commodity flows at ports, which may be seasonal and may vary. The technical solution according to embodiments of this invention is to sample jitter and packet loss via emulation or observation, for example, and use the distribution to compute service time/capacity in transportation network model (e.g. discrete event simulation or optimization). However, known systems and models do not provide this ability.

### BRIEF DESCRIPTION OF THE DRAWINGS

The disclosure can be better understood with reference to the following drawings and description. The components in the figures are not necessarily to scale, emphasis instead being placed upon illustrating the principles of the embodiments. Various exemplary embodiments of the subject matter disclosed herein are illustrated in the accompanying drawings in which like reference numerals represent like parts throughout, in which:

FIG. 1 is a high-level flow diagram that illustrates a sequential coupling scheme between an optimization engine and a simulation engine of a simulation system or risk evaluation tool and system, according to one embodiment.

FIGS. 2A-2D are illustrations of a transportation network G, a set of commodities K, and a set of commodity paths P according to one embodiment.

FIG. 3 is a diagrammatic view of a cyber-physical model for container export operations as a layered network, according to one embodiment.

FIG. 4A is a flow diagram demonstrating the operation of the coupled optimizer-simulator, according to one embodiment.

FIGS. 4B-4E are graphs corresponding to FIG. 4A.

FIG. 5 is a high-level block diagram of the simulation system or evaluation tool, including the core modules, extension modules, analytic modules, and the user interface (UI) for the simulation-optimization engine, according to one embodiment.

FIGS. 6A-6B is a 2 page table showing various threats or disruption types.

FIG. 7 is a pictorial representation showing resources within multiple infrastructures, not necessarily limited to a shipping port environment, according to one embodiment.

FIG. 8 is a pictorial representation showing a cyber-physical layer at a shipping port, an automated straddle carrier, and a control center, according to one embodiment.

FIG. 9A indicates the resources in a transportation network that are disrupted, while FIGS. 9B, 9C, and 9D show the effect of the disruption of FIG. 9A on various stakeholders, according to one embodiment.

FIG. 10 is a pictorial view showing a disruption outside of a shipping port, which has a regional effect, according to one embodiment.

FIG. 11 is a pictorial view showing a disruption in the shipping port, which also has a regional effect, according to one embodiment.

FIGS. 12A-12C are bar charts showing the economic impact of a 10-day gate disruption, according to one embodiment.

FIGS. 13A-13C are bar charts showing the economic impact of a multiple disruptions, according to one embodiment.

FIG. 14 is a block diagram of a computer system that may be used to run the simulation system or evaluation tool, including the simulation engine and the optimization engine, according to one embodiment.

FIG. 15 is a two-page table showing exemplary mitigation actions, according to one embodiment.

FIG. 16 is a two-page table showing exemplary response/recovery actions, according to one embodiment.

FIG. 17 is a sample schedule of disruptions, mitigations, and response/recovery actions input to the simulation system or risk evaluation tool, according to one embodiment.

FIG. 18 is a table of Key Performance Indicators (KPI) that may be computed by different analysis modules, according to one embodiment.

FIG. 19 is an exemplary table of data sources used to populate simulation/optimization context, according to one embodiment.

FIG. 20 is a pictorial diagram showing a multilayered network, including critical infrastructure sectors for a transportation domain and a cyber domain, corresponding to two exemplary stakeholders.

FIG. 21 shows a multilayer network threat pattern illustrating a degraded network in the cyber domain (Gate Operating System), which leads to a downstream, or secondary effect in the transportation domain, according to one embodiment.

FIG. 22 is a UML sequence diagram illustrating arrival of a truck at a gate, according to one embodiment.

FIG. 23 is a high-level block diagram showing system architecture of an exemplary simulation engine and emulation engine, according to one embodiment.

FIG. 24 is a chart and graph illustrating the impact of degrading database access via a denial of service attack (TCP RST), which targets a gate kiosk server, according to one embodiment.

FIG. 25 is a chart and graph illustrating the impact of disruptions to VOIP (Voice Over IP) and video on shipping port operations, according to one embodiment.

FIG. 26 is a simplified flowchart for embodiments of FIGS. 21-25.

### DETAILED DESCRIPTION

The various features and advantageous details of the subject matter disclosed herein are explained more fully with reference to the non-limiting embodiments described in detail in the following description.

As discussed in the background of this document, shipping ports are a nexus of critical infrastructure. Within a small geographic region, multimodal transportation systems intersect with increasingly automated shipping port operations. Given that environmental conditions as well as the capabilities of intelligent adversaries are increasing, stakeholders at local ports and regional AMSCs need the ability to develop and evaluate their security plans against the possibility of disruptions across multiple critical infrastructure sectors. The ability provided by embodiments of the simulation system or evaluation tool allows practitioners to understand how such disruptions affect the flow of commodities through the MTS (via the simulator) while simultaneously helping them to design security plans around optimal responses to such disruptions (via the optimizer engine). Such a capability is essential given the degree to which modern commerce depends upon the efficient and resilient operation of shipping ports.

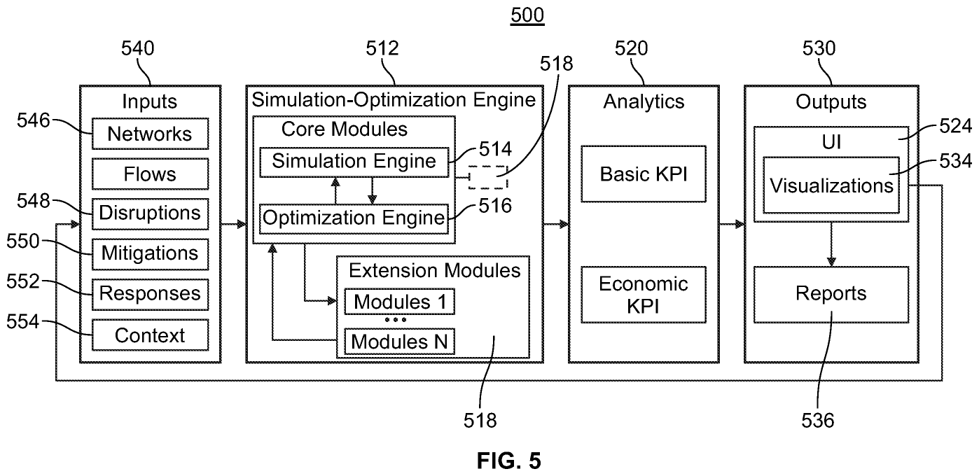

FIG. 5 is a high-level block diagram of the various components of a simulation system or evaluation tool 500, including a simulation-optimization engine 512, which may include a simulation engine 514 and an optimization engine 516. The simulation engine 514 and an optimization engine 516 may be separate and distinct components or modules, or alternatively, may be combined into a single component or module, namely, the simulation-optimization engine 512. In one embodiment, an optional emulation engine 518 may be included. Further, the simulation-optimization engine 512 may include simulated components.

The simulation system or evaluation tool 500 may also include a plurality of extension modules 516, analytics modules 520, and a user interface (UI) 524. The UI 524 may be operatively coupled to an output engine 530 configured to provide a visual representation (visualizations) 534 of the plurality of commodities flowing through one or more network layers, and may generate reports 536 selectable through the user interface 524. This block-diagram of the simulation system or risk evaluation tool 500 will be discussed in the context of a typical execution of the simulation-optimizer engine or system 512.

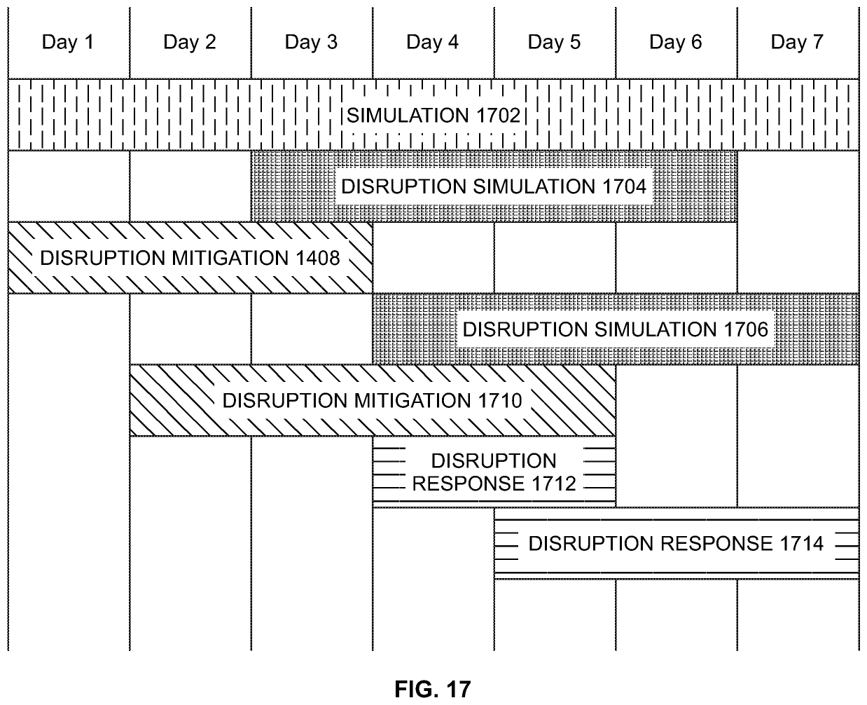

In some embodiments of the present invention, a typical execution of the simulation-optimization engine 512, as shown in FIG. 5, inputs 540 to the simulation-optimization engine 512 include, but are not limited to: (1) defining domains or networks for a subject area 546, including their respective graph layers and associated flows, (2) selecting one or more disruption models 548 and a disruption context, (3) selecting one or more mitigation models 550 and a mitigation context, and (4) selecting one or more response/recovery models 552 and a response/recovery context 554. Flow models 556 may also be established. These inputs 540 may be specified via a user interface 524 as shown in FIG. 5. This UI 524 may schedule such events (i.e., define the context of such events) as shown in FIG. 17.

In some embodiments of the present invention, a typical execution of the simulation system or evaluation tool 500 and/or the simulation-optimization engine 512 may be as follows: Commencing execution, the simulation system or evaluation tool 500 may determine one or more domains for a subject area. Each domain may correspond to a critical infrastructure sector. As mentioned above, domain areas may include transportation, power, and cyber (e.g., communications/IT). A subject area may encompass a geographic location, such as a maritime port. The subject area may also include infrastructure dependencies that are beyond the specific geographic location (e.g., cloud infrastructure in the cyber domain). The one or more domains and the subject area may be defined by a user or determined in response to user input, for instance in response to receiving geographic attributes from the user.

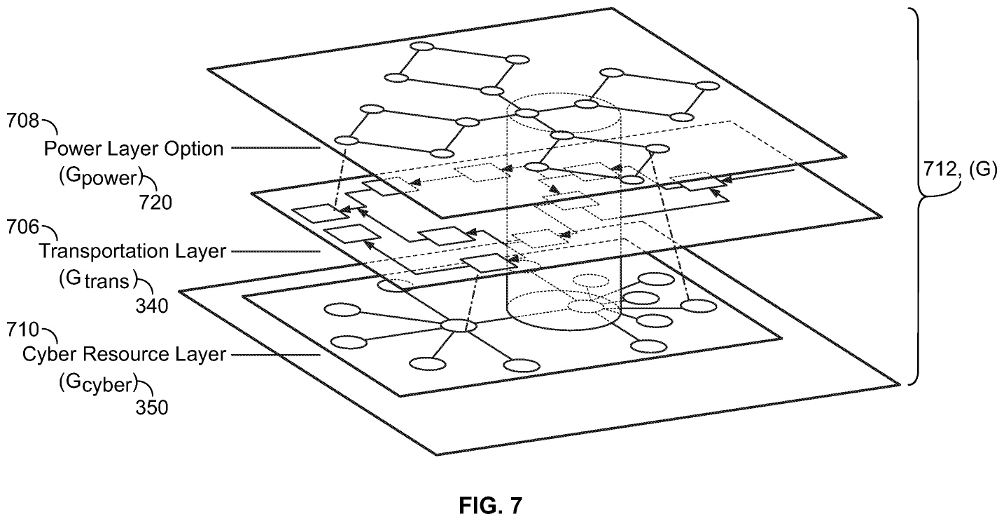

FIG. 7 is a pictorial representation showing that embodiments of the simulation system or risk evaluation tool 500 are not necessarily limited to a transportation layer 706 or a network of a shipping port environment, but are also applicable to resources within multiple infrastructures, which may be unrelated to the shipping port, such as resources within a power distribution layer or network 708 (e.g., the electrical grid) and/or resources within a cyber-physical layer 710, not necessarily closely associated with the shipping port itself. The association of these various multiple layers 712 are shown by the interaction between the layers of FIG. 7.

Embodiments of the simulation system or evaluation tool 500 may simultaneously simulate and optimize all layers 712 (G), such as the transportation layer 706 of a shipping port, an electrical layer or grid 708, the cyber-physical layer 710 and the like. Note that the transportation layer 706 may also be external to the shipping port, such as a transportation layer representing roads, highways, bridges, rail system, public transit, and the like.

Each graph layer 712 is associated with a type of network and a respective type of flow. For example, the transportation layer 706 may describe a transportation network (e.g., rail, roads, inland waterways, air routes, vessel routes, among others) associated with one or more commodity flows (e.g., traffic flow, flow of commodity types as defined by NAICS, among others).

The cyber or cyber-physical layer 710 may describe a communications/IT network (e.g., local area networks, wide area networks, wired/wireless communications, vehicle ad hoc networks, IT/OT networks, electronic data interchange, automatic identification systems, global positioning systems, Internet, voice networks, closed circuit security systems, IoT sensor data, among others), and the like, which may be associated with one or more data flows.

The power layer 708, in turn, may be associated with an electrical power grid (e.g., generation, transmission, and distribution of electrical power) corresponding to electrical power flow (e.g., power flow and associated communications/IT for protection schemes, among others).

Additionally, each of the plurality of graph or domain layers 712 may show different levels of granularity depending upon the needs and/or availability to the operator of the simulation system 500. Different specialists may have access to higher-fidelity models of each layer 712 (e.g., based on security access controls). A power engineer may have access to the entire distribution and protection system of a power company serving a shipping port. However, due to sensitivity issues, this level of detail may be unavailable to a port stakeholder, such as the captain of the port. In this context, the port stakeholder may have access to a simpler, collapsed model, which may show only the relevant aspects to the port stakeholder. This allows domain specialists may explore cross-domain dependencies without having access to an excessive amount of detail.

One approach to providing graph models of varying levels of granularity is to employ a hierarchy tree view on a graph layer. A hierarchy tree is a tree whose leaves correspond to vertices in the graph layer. By specifying a set of subtrees that partition the vertices in the graph layer, a view on the graph at different levels of detail may be generated.

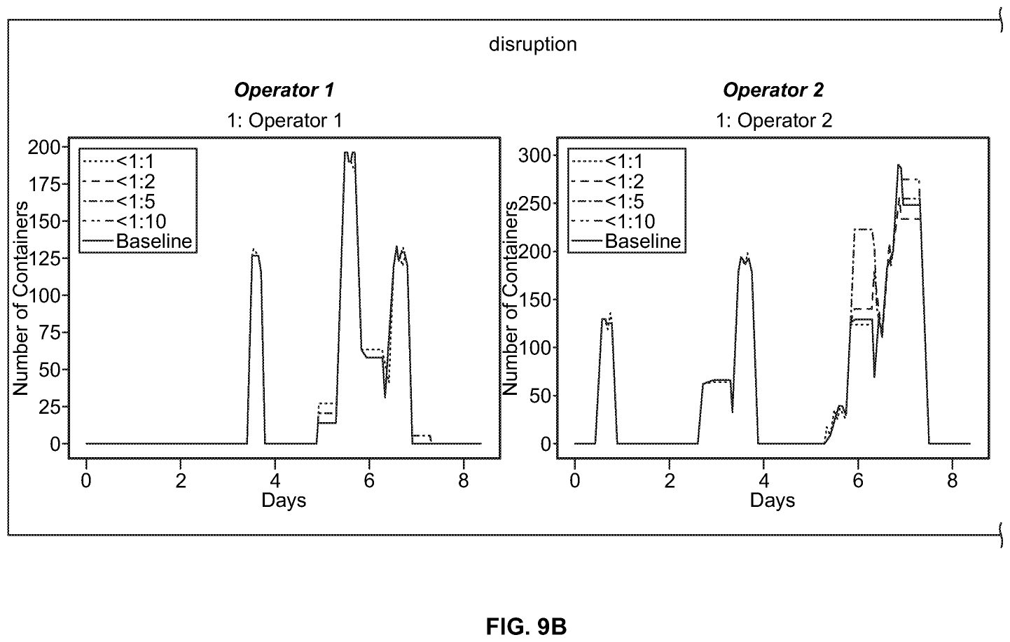

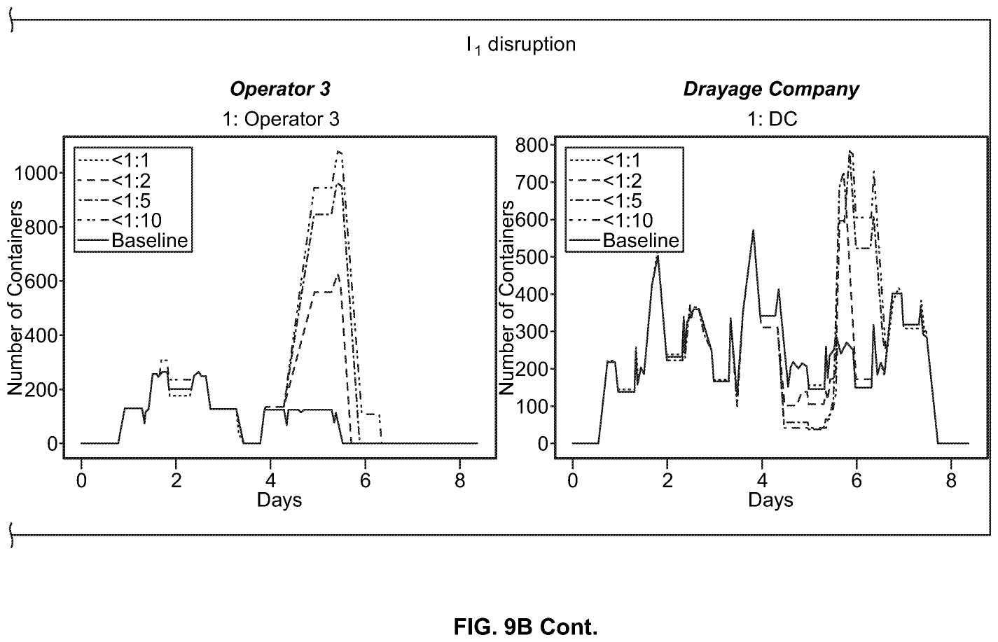

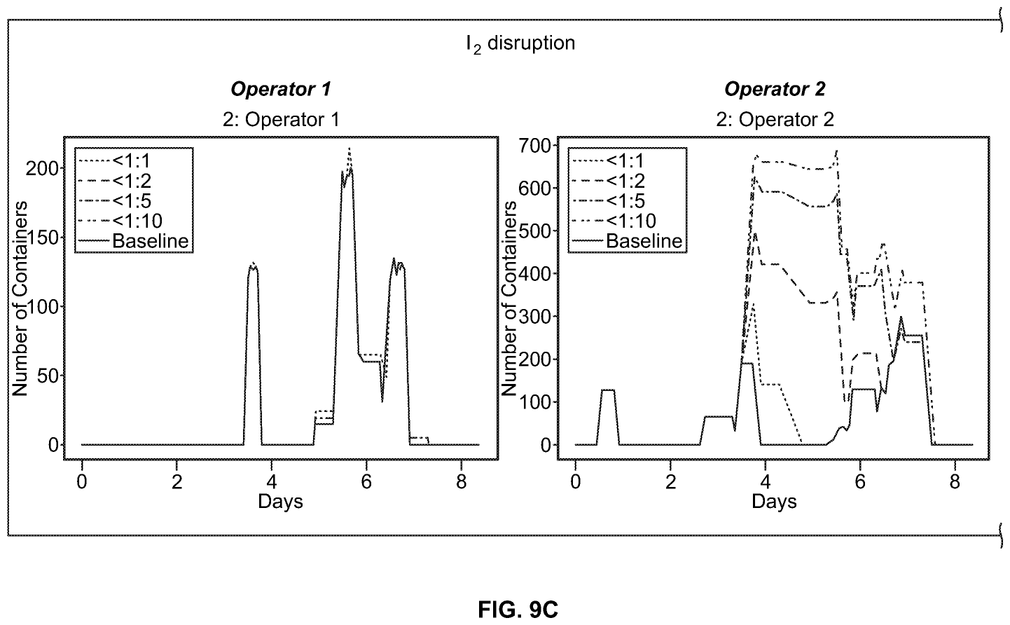

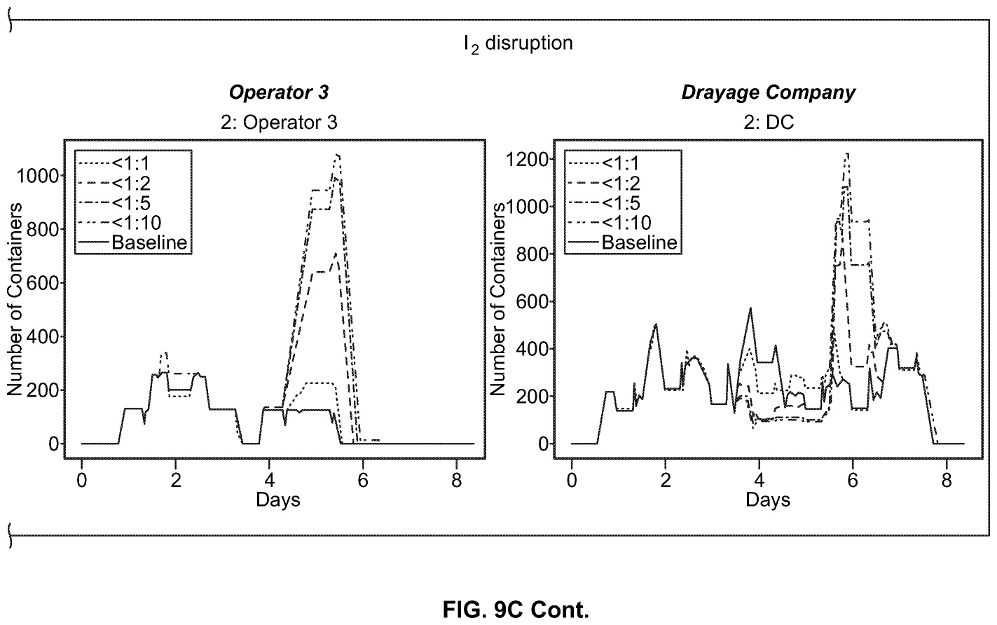

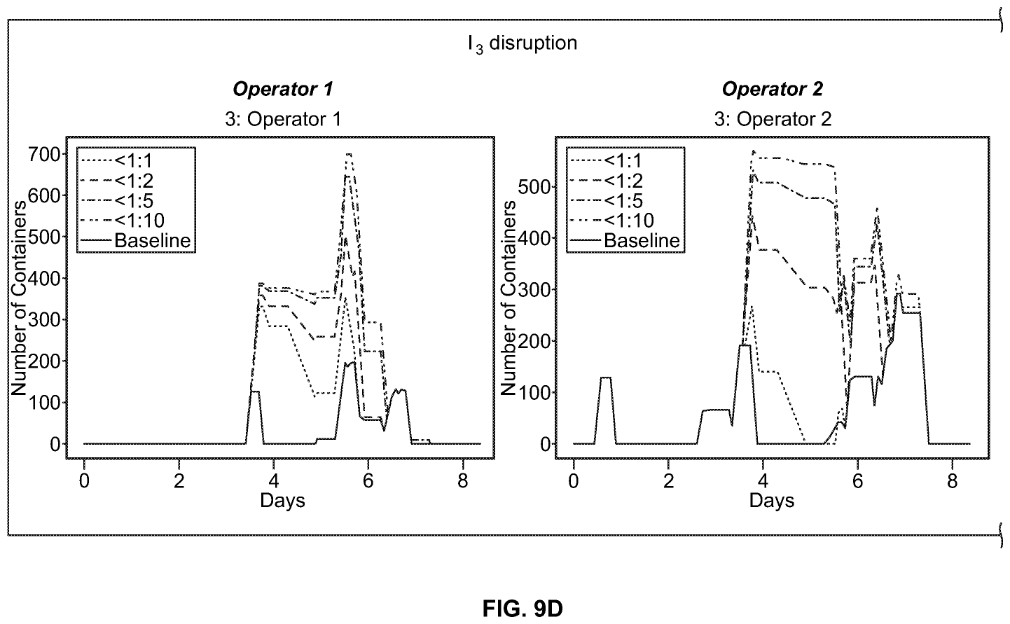

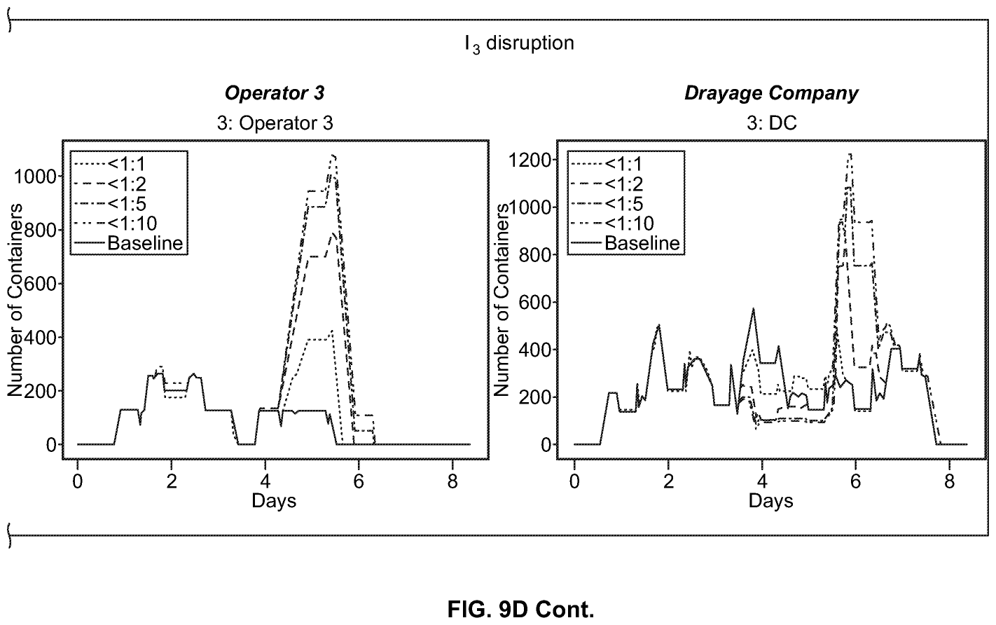

For example, FIG. 9A illustrates a graph layer 900 for a shipping port transportation network. Subgraphs 910 of this network, denoted by dashed lines, which enclose regions specific to a given stakeholder (e.g., Truck Company, Terminal Operators), may be represented as subtrees within the hierarchy tree. In this manner, Yard 3 916 could be expanded to provide a more detailed graph of Terminal Operator 3's operations for an authorized stakeholder.

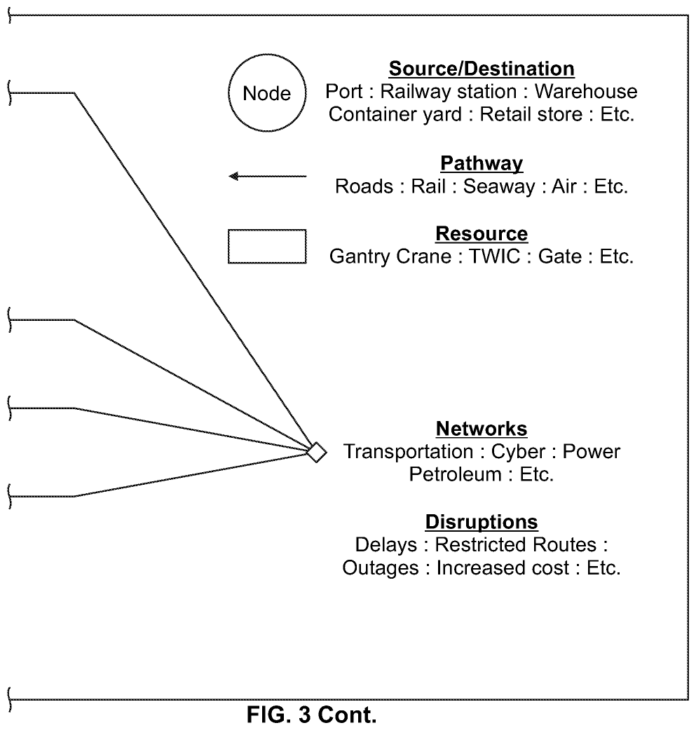

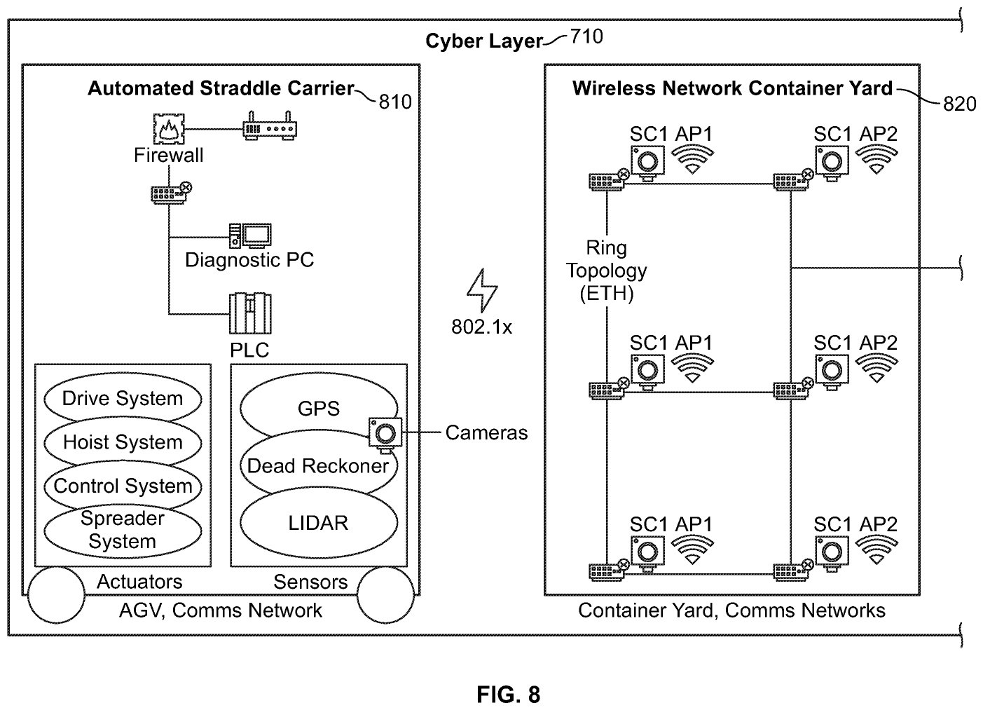

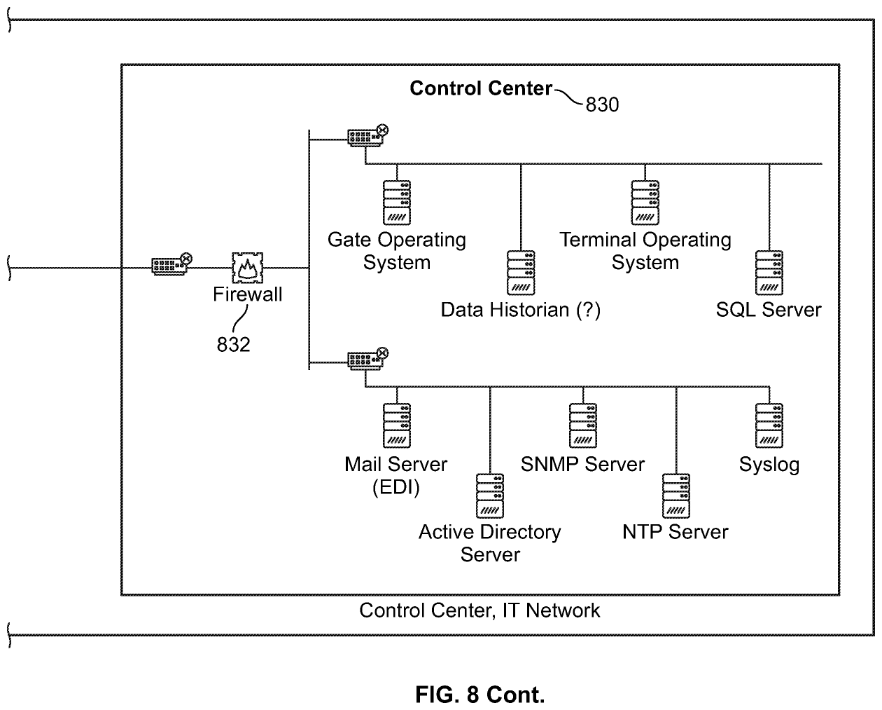

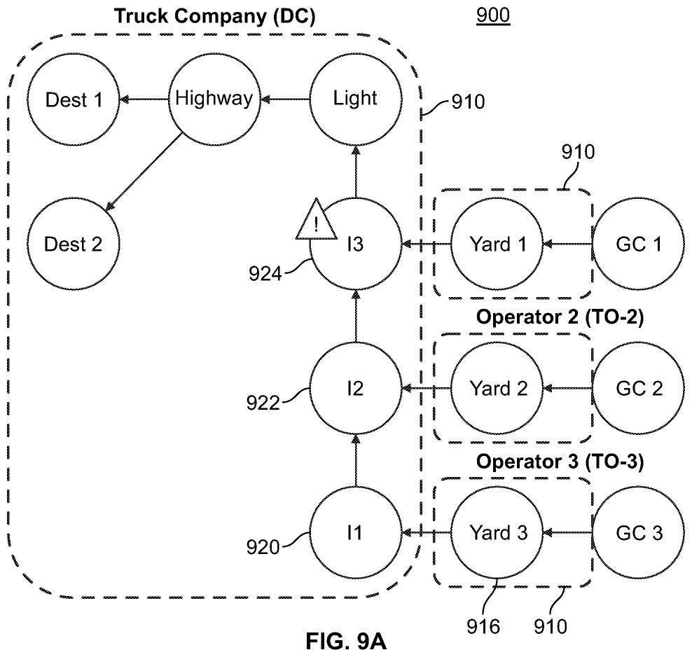

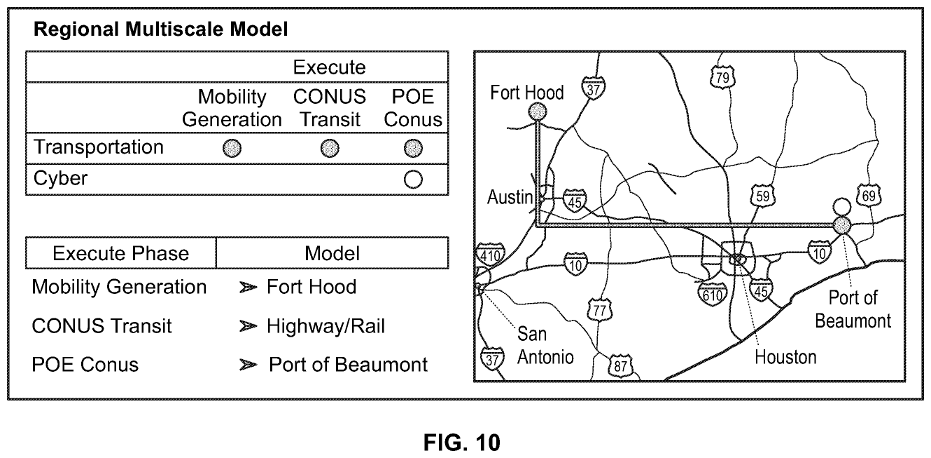

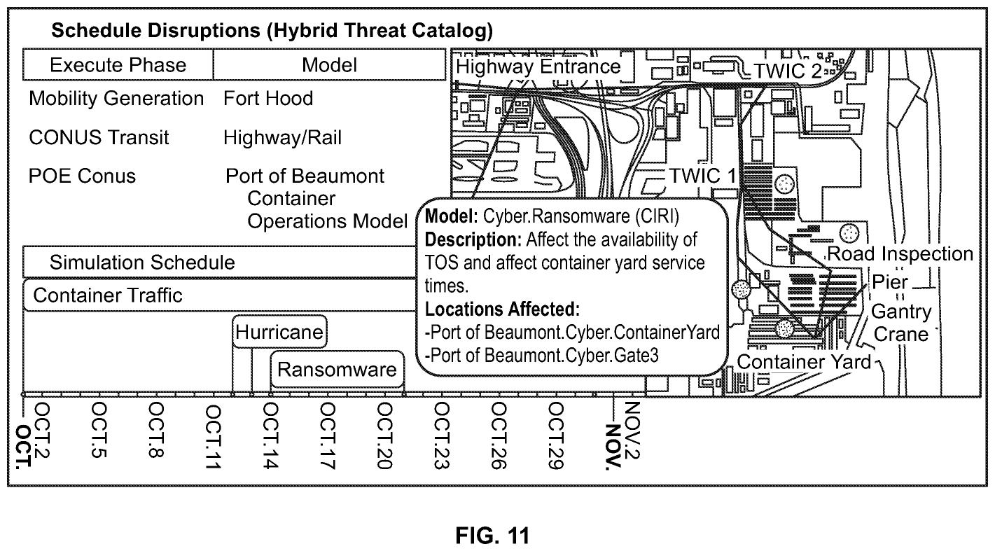

Such a mechanism may be used to navigate from the level of detail in FIG. 10, to that of FIG. 11 when zooming in on a geographic region. In addition, one could expand the Cyber Layer components of FIG. 3 to show the underlying system details in FIG. 8.

In that regard, FIG. 8 is a pictorial representation showing a cyber-physical layer 710 at a shipping port, and in particular, illustrates an automated straddle carrier 810 for moving containers about the port area automatically without human control. Also shown is the corresponding wireless network 820 in the container yard used to control the automated straddle carrier 810, and connection between the wireless network 820 and the control center 803, separated by a firewall 832.

As illustrated, a disruption in the wireless network may cause disruption or stoppage of the straddle carrier 810, resulting in a disruption of the flow of containers about the shipping yard. The integrated simulation engine and optimization engine 512 of the simulation system or risk evaluation tool 500 may be configured to simulate and optimize the path when such a disruption occurs to a resource, such as to the wireless network resource 820.

Cross-domain dependencies may be represented as interactions between graph layers. Cross-domain dependencies may also be expressed as a function of graph layers. For example, a dependency of graph layer A upon graph layer B may be expressed as a function where the state of graph layer A is the output of a function on the state of graph layer B.

FIG. 3 shows interactions between an exemplary transportation layer 706 and an exemplary cyber resource layer 710. In this exemplary model, the interactions between components of the cyber resource layer 710 and the transportation layer 706 may be shown in relation to a plurality of logic gates 310 that control cyber-physical components in the transportation layer (e.g., a gantry crane 312, gates or gate kiosks 320). A graphical representation for an exemplary set of transportation, power, and cyber graph layers 712 is also shown in FIG. 7.

As mentioned in relation to FIG. 8, a disruption in a component of the cyber layer 710 may cause disruption or stoppage of a cyber-physical component, resulting in a disruption of the flow of containers in a shipping yard. The simulation system or risk evaluation tool 500 may provide means to evaluate how the interruption of a particular flow in one layer affects the operation of the rest of the system.

FIG. 3 is a diagrammatic view of a cyber-physical model for container export operations as a layered network. The graph in the top row, shown as multiple circular objects, illustrates the flow of export commodities from a distribution center to a vessel. The leftmost column enumerates different systems provided by the Communications/IT infrastructure that are necessary for efficient operation. The latter is related to the former via data dependencies such that latencies in the availability of data within the cyber system affect service times in the intermodal transportation system. The communication/IT sector assets or resources are further explained below in Table 1:

TABLE 1

| Com- | |
|---|---|
| munica- | |
| tions/IT | Sector Assets |
| AIS | The automatic identification system (AIS) is another essential |
| | maritime network and protocol designed to supplement marine |
| | radar systems and serve as a redundant method for preventing |
| | ship collisions at sea, the AIS connects near real-time |
| | information between nearby ships through AIS base stations |
| | and satellites. |
| EDI | Data is commonly passed between the TOS and terminal |
| | clients in Electronic Data Interchange (EDI) files- |
| | standardized electronic formatting of business documents |
| | sent to parties through a computer-to-computer exchange. |
| OCR | Optical Character Recognition (OCR) systems are used at the |
| | Terminal Gate to collect and analyze optical data such as |
| | license plates, chassis information, container details, and |
| | potential container damage. |
| RFID | Passive Radio-Frequency Identification (RFID) tags are issued |
| | and placed on vehicles belonging to truck drivers and trucking |
| | companies that have legitimate business at the terminal, |
| | enabling faster movement through the gate and efficient |
| | tracking of the vehicle through the terminal. |
| TOS | The Terminal Operating System (TOS) monitors and manages |
| | the movement of containers in and out of a terminal. Several |
| | TOSs can be used in one port at different terminals, or one |
| | TOS can be used across multiple terminals [3]. |
| TWIC | According to the Maritime Transportation Security Act |
| | (MTSA) of 2002, truck drivers and others entering the |
| | terminal must have a Transportation Worker Identification |
| | Credential (TWIC) card scanned by a TWIC reader at the |
| | gate. The reader passes the TWIC information |
| | to the terminal's access control system, which authenticates |
| | the driver via biometrics or personal identification |
| | number and confirms the driver has authorized access. |

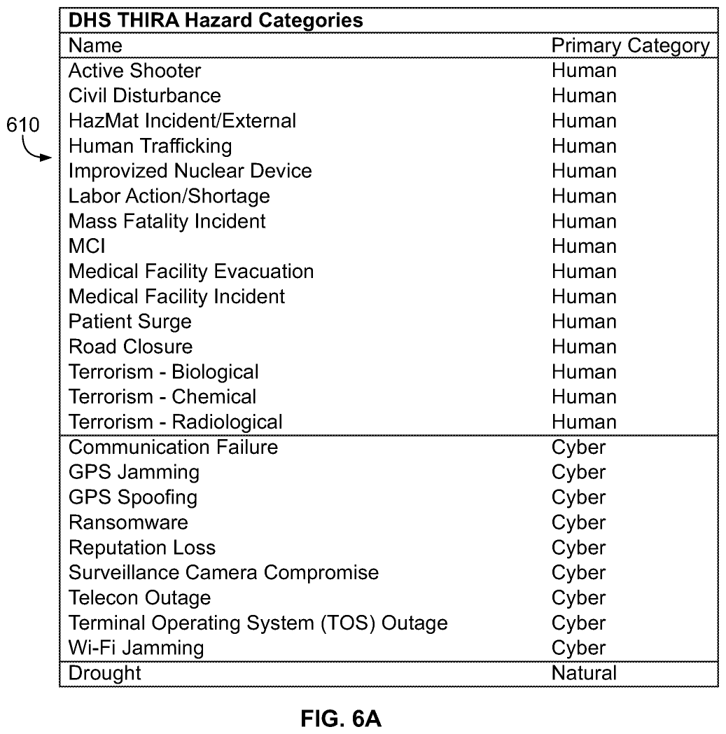

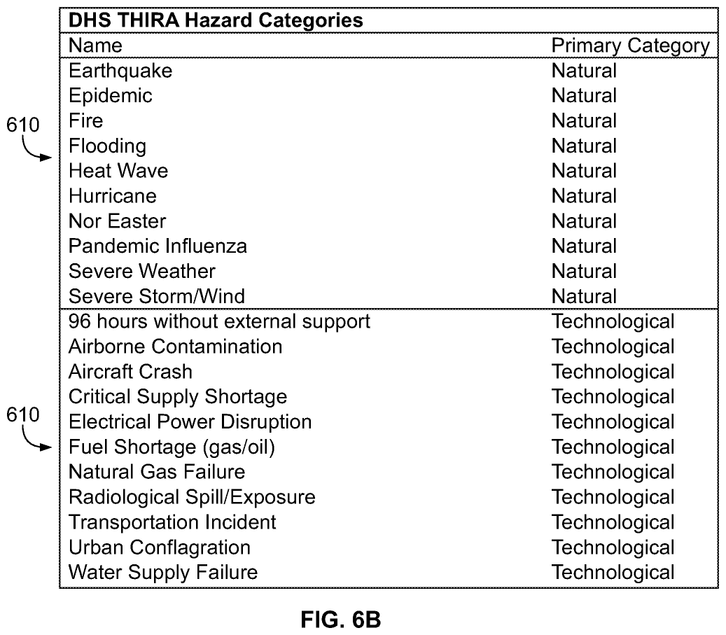

The simulation system or evaluation tool 500 may determine one or more disruption models. A disruption model describes a type of event that causes the parameters for one or more of the layers or network domains 712 to be altered to simulate a disturbance or problem in the system. Disruption models may also include any type of event that causes a compromise of availability, integrity, or confidentiality in the subject area. Exemplary disruption models 610 are described in FIGS. 6A and 6B, and correspond to threat descriptions.

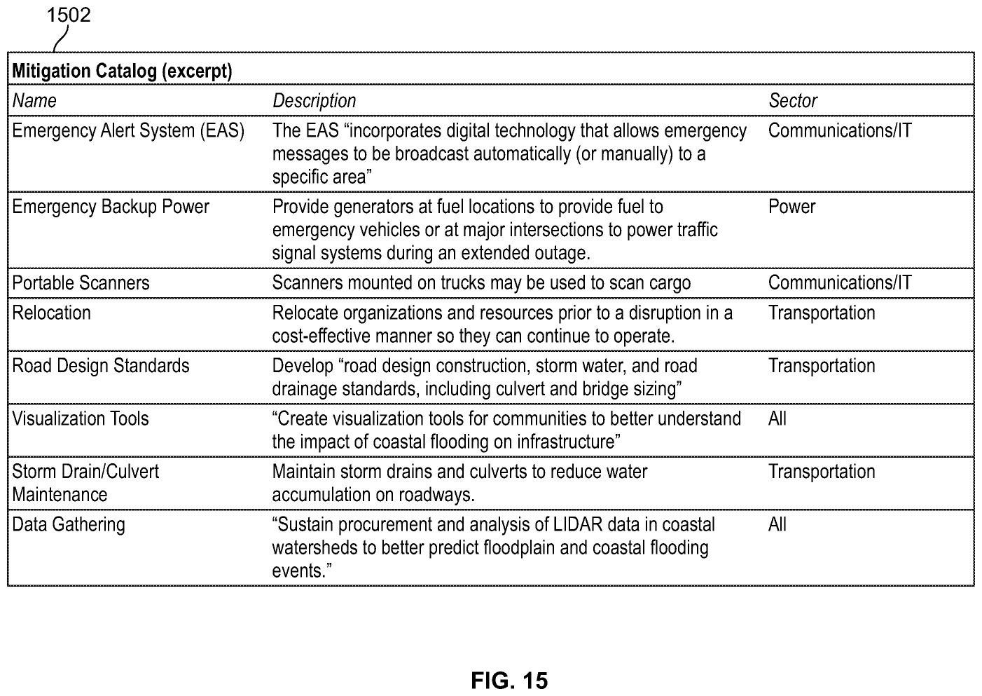

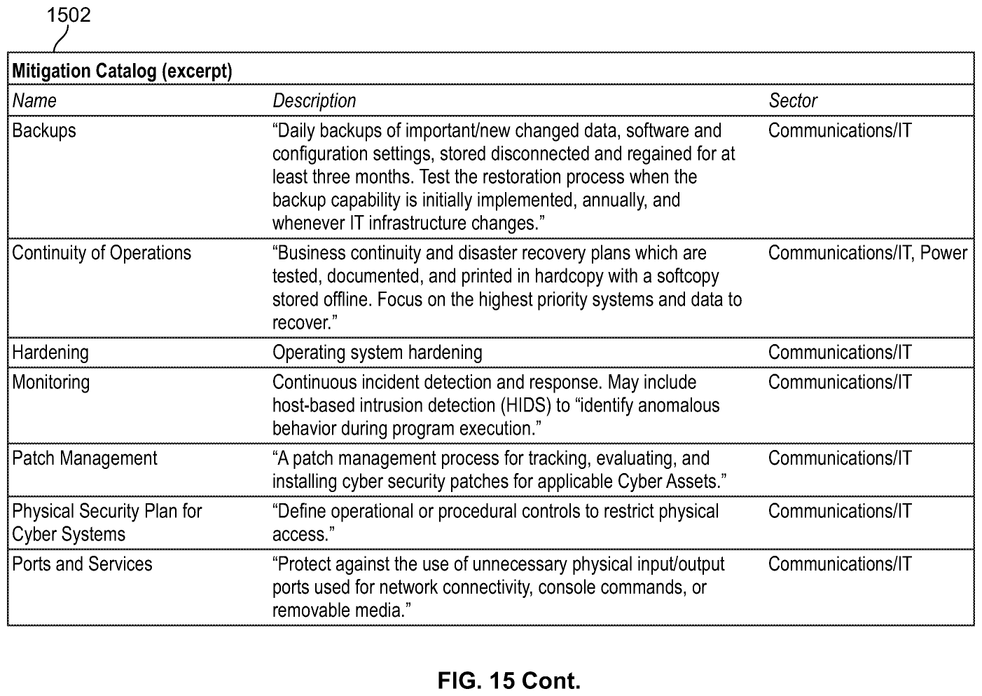

The simulation system or evaluation tool 500 may determine or select one or more disruption mitigation models 1502 for each disruption model 610. Disruption mitigation models 1502 may describe actions taken to eliminate or reduce the impacts and risks of each disruption model 610 through proactive measures taken before the disruption occurs. A disruption mitigation model 1502 describes a type of event that occurs before a disruption causes the parameters for one or more of the layers 710 to be altered so as to simulate a proactive approach, which may lessen the impact of the disruption in the system. This may permit the operator to evaluate the effectiveness of specific mitigation actions in light of specific disruption models 610. Exemplary disruption mitigation models 1502 are described in FIG. 15.

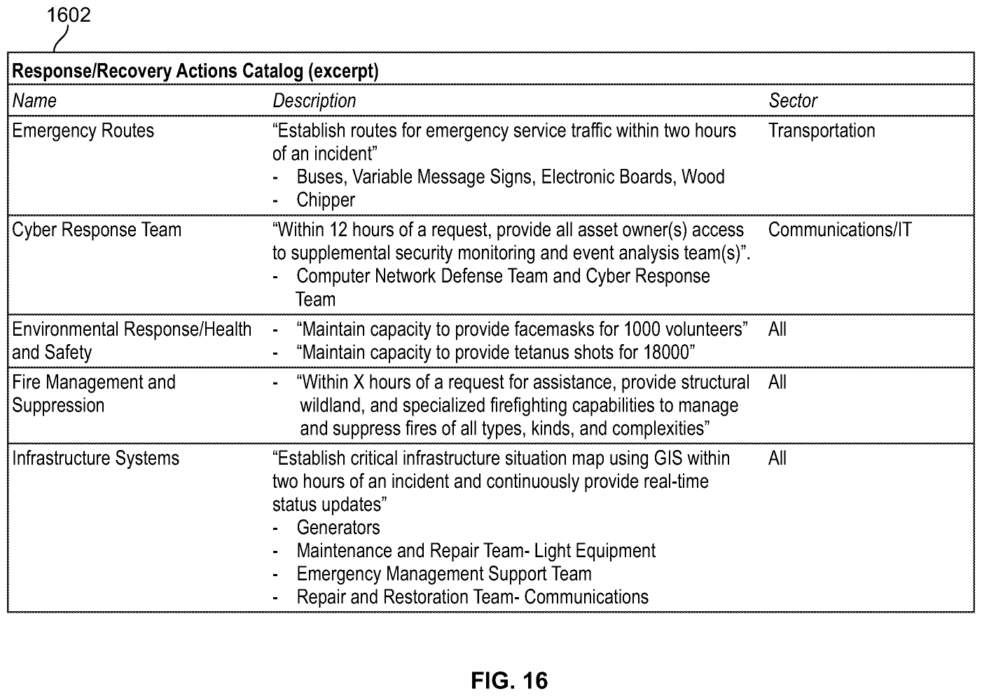

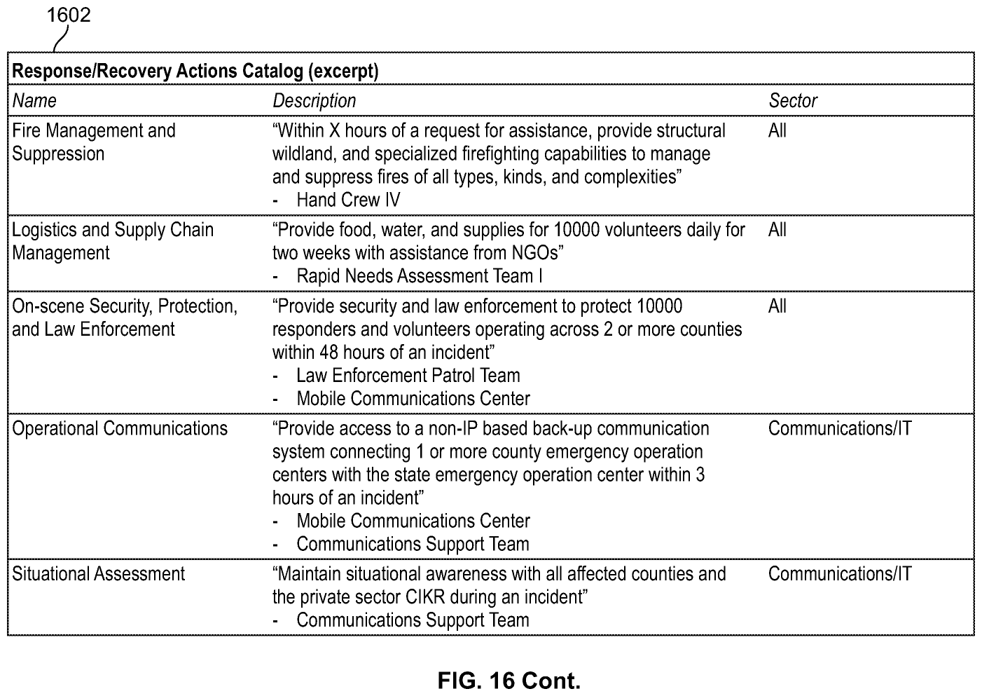

The simulation system or evaluation tool 500 may determine one or more disruption response models 1602 for each disruption model 610. Disruption response models 1602 describe actions taken to eliminate or reduce the impacts and risks of each disruption model 610 through reactive measures taken after the disruption occurs. A disruption response model 1602 describes a type of event that may occur after a disruption causing the parameters for one or more of the layers to be altered, so as to simulate a reactive approach to lessen the impact of a disruption in the system. Disruption response models 1602 allow the operator to evaluate the effectiveness of specific response actions in light of specific disruption models 610. Exemplary disruption response models are 1602 are described in FIG. 16.

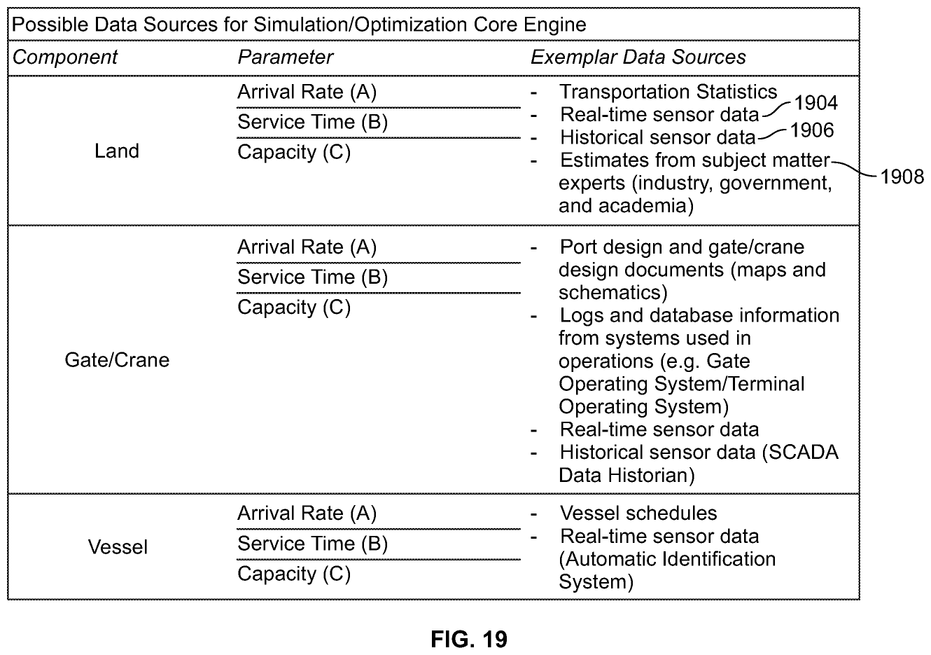

Turning now to FIG. 19, in some embodiments of the present invention, the simulation system or evaluation tool 500 may determine a simulation context for a predetermined subject area. The simulation context may include time, duration, resources (e.g., type of machinery available), resource schedule, data sources used to populate model parameters, and supply and demand for different types of flows, among other factors. As shown in FIG. 19, data sources 1902 used to populate model parameters may include real-time sensor data 1904, historical sensor data 1906, and estimates from subject matter experts 1908, among other sources.

The simulation system or evaluation tool 500 may determine or generate a simulation model. In some embodiments, the simulation model for the transportation layer 706 may be a discrete event simulation, where events may consist of arrival and departure of vehicles (e.g., vessels, trucks, trains, among others) as well as the movement of commodities of different types. In some embodiments, the simulation model for the power layer 708 (Gpower 720) may be given by power-flow equations, where flow of electrical power depends upon the generation, transmission, distribution, and demands for electrical power as described in the power layer. In some embodiments, the simulation model for the cyber layer 710 may be a discrete event simulator of network traffic, where events may consist of the protocols and data that is transmitted through the network. A simulation model for a cyber layer 710 may also include virtual resources using, for example, lightweight containers, virtual machines, and/or system emulators.

The simulation engine 514 or simulation-optimization engine 512 enables stakeholders to experiment—through “what if” scenario analyses—with interactions between the availability of communications/IT services and the throughput of the shipping port transportation network. Using this engine, researchers can understand the effect of disruptions to the shipping port, for example. Given a schedule of commodities and an infrastructure graph, this discrete time (DT) stochastic simulation using the simulation system or evaluation tool 500 may computes a behavior trace that describes the flow of commodities through a shipping port's commodity transportation system or transportation domain. Also described below are embodiments directed to modeling cyber-physical disruptions to the MTS.

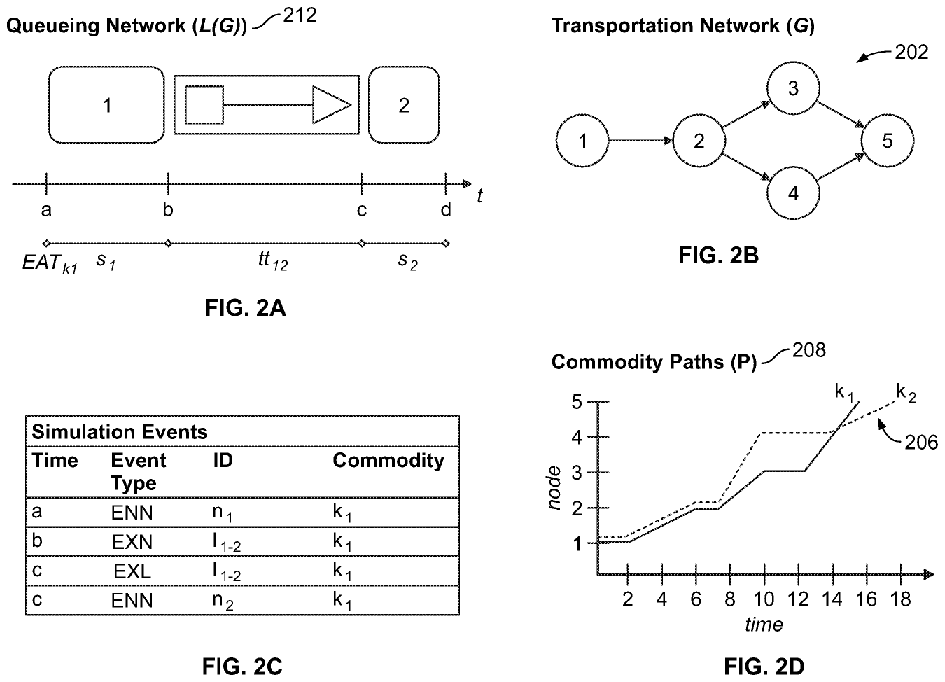

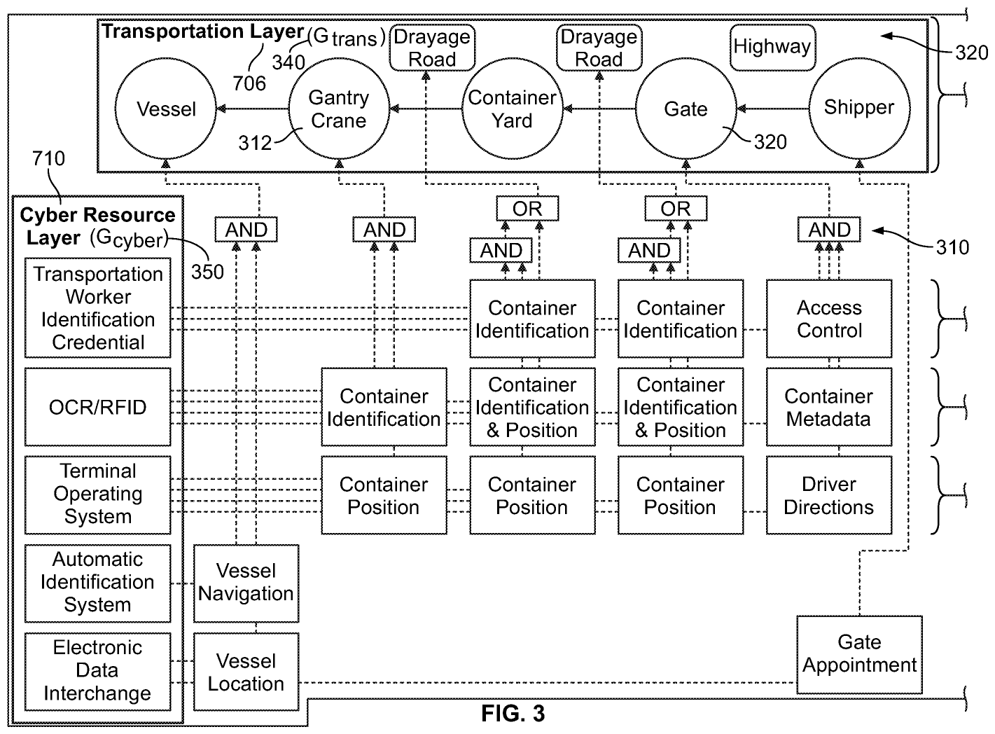

Referring to FIGS. 2A-2D, further inputs to the simulation engine 514 may include a graph-based representation of the transportation network topology (G) 202, a set of commodity units (K) 206 that must be routed through this graph, and a set of paths (P) 208 that commodities take through the network. In one embodiment, simulator inputs may be encoded within JSON file formats for both the transportation network and commodity units as well as via a text-based format that encodes per-commodity unit paths. However any suitable encoding may be used. Table 1 below provides an overview of simulation module inputs and outputs.

An input graph (G=(V, A)) is used to instantiate a queueing network L(G) 212. The behavior of such a queueing network 212 may be simulated via discrete event simulation. The queuing network 212 may be given by L(G)=(N, E) whose nodes n E N correspond to link entrance and exit buffers as shown in FIG. 2. In addition to the transportation network topology, additional model parameters from the optimization engine 516 may be used to instantiate the service time distribution for each node in the queueing network (Bᵢ), the number of parallel servers at a node (cᵢ), and the number of commodity units that can wait to be serviced at a node (Nᵢ). More details about how the optimization model parameters might be used to instantiate model parameters are provided in Table 2 below. Commodity shipments (K) and paths (P) describe each of the commodities to be scheduled and their optimal path through the transportation network (G) 202 respectively.

Given these inputs, the simulation propagates commodities through the queueing network via the process of node transfer and link traversal. Using this approach, the module schedules, processes, and computes cumulative counts for various events shown below in Table 2 below.

TABLE 2

| | | |
|---|---|---|
| | | Relation to Optimization |
| Parameter | Description | Module Parameters/Outputs |

Simulation Input Variables (u_{B})

| | | |
|---|---|---|
| (Aᵢ) | Arrival times for each | Based on the commodity |
| | commodity unit at a node | path Pkᵤ ϵ P. |
| | in the queueing network. | |
| (Bᵢ) | The service time | Based on travel time/ |
| | distribution at a node in the | service times (Sᵢ, ttᵢₕᵢ) for |
| | queuing network. | corresponding |
| | | edge or vertex in G. |
| (Cᵢ) | The number of parallel | Based on capacity of an |
| | servers at a node in the | edge (uᵢₕⱼ₎ in G. |
| | queuing network. | |
| (Nᵢ) | The number of commodity | Based on capacity of an |
| | units that can wait to be | edge (uᵢₕⱼ) in G. |
| | serviced at a node. | |
| (K) | The total number of | Given by commodity |
| | commodity units that may | shipments in K. |
| | be served. | |

Simulation Output Variables (y_{B})

| | |
|---|---|
| [symbol] xₖᵤ [symbol] | A per-commodity unit state trajectory that relates the co- |
| | simulation time base T to one of the nodes in the |
| | queueing model. |

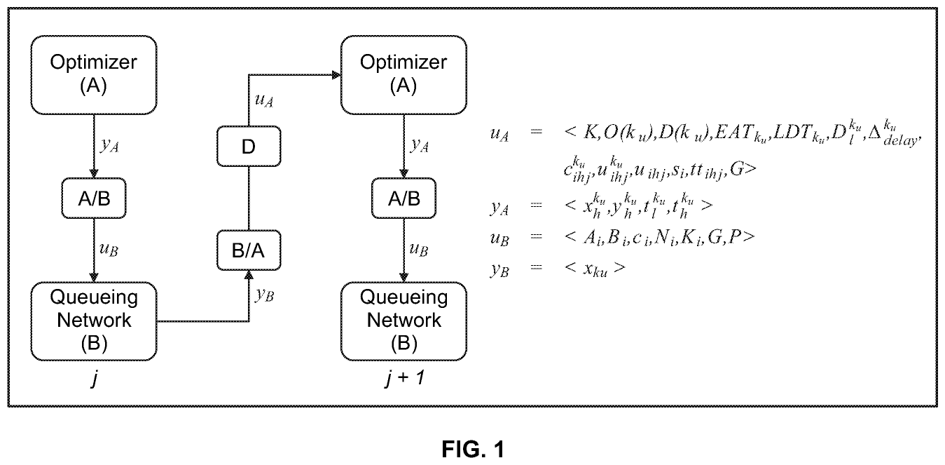

Table 2 above shows input and output variables for the simulation engine 514. Simulation model parameters are based on Kendall's notation with slight modifications due to coupling with the optimization module. For example, Aᵢ is defined with node arrival times for each commodity kᵤ ∈K rather than a distribution of arrival times. These variables are used by the co-simulation shown in FIG. 1.

Further, FIGS. 2A-2D may show a given transportation network G, a set of commodities K, and a set of commodity paths P, where the simulation model schedules and processes commodity link arrival and link departure events. The link-based queueing network is instantiated from G by associating an entrance and exit queue with every edge in G. The relation between the timing of these events, as well as movement of commodities along optimal paths, is shown in FIGS. 2A-2D. For example, commodities k₁, k₂ ∈K both move through the network, but take different paths, the former going through node 3 220 while the latter through node 4 222.

FIGS. 2A-2D also show the number of commodities that have ENtered (EN) and EXited (EX) a link (L) or node (N). Commodities (K) are scheduled to flow relative to the optimal paths P. FIGS. 2A-2D illustrate commodity shipment k₁ arriving at its source node (O(k₁)=n₁) at time a=EATₖ₁(ENN), being serviced, and exiting the source node at time b=a+sₙ₁. In general, a≥EATₖ₁ and b≥a+sₙ₁. Upon exiting the node (EXN), the commodity is assumed to immediately enter the next link l on its path (ENL) where it is queued at the entrance node for that link 1. In the process of link traversal, a commodity is removed from the entrance queue at time b and added to the exit queue at time c=b+tt₁.

Although FIGS. 2A-2D show the commodity immediately exiting link 1 after link traversal, time c≥b+tt₁, as commodities may wait to exit the link in the general case (e.g., due to downstream link capacity, in the process of node transfer, commodities are moved from the exit buffer of a node's incoming link to the entrance buffer of the node's outgoing link. Other embodiments may take a different approach. For example, commodities may arrive at a node via a link, be processed at the node, and move to an exit link.

The optimization engine 516 may analytically computes a schedule for how to route multiple commodities with minimum cost. Unexpected disruptions due to changing environmental and adversarial conditions make determining optimal routes for commodities even more challenging. Therefore, the optimization engine 516 may implement a multicommodity optimal network flow algorithm to help stakeholders minimize the impact of disruptions in a cost-effective manner. The challenge of these approaches is to compute commodity routes in a time and space-efficient manner. The optimization engine 516 may use discrete time to deterministically compute an optimal schedule to move commodities through the shipping port's transportation network. Other embodiments disclose the formulation of this system to support decisions made by the AMSCs to prepare and recover from a disruption.

The multicommodity optimal network flow provides an optimal way to deliver commodities through the MTS network. Table 3 below provides an overview of different input model parameters for the ONF formulation. These parameters may be used within FIG. 1 to describe input and output variables within the co-simulation.

Table 3 shows input and output variables for the optimization module. The module is implemented as a multicommodity network flow algorithm in which containers flow from a source to a destination node within the transportation network. These variables may be used by the coupled optimizer-simulator representation shown in FIG. 1.

TABLE 3

| | | | |
|---|---|---|---|
| Parameter | Description | Parameter | Description |

Optimizer Input Variables (u_{A})

| | | | |
|---|---|---|---|
| K ⊆ [symbol] | The set of all commodities. | O(kᵤ) | The source of commodity |
| | For all k ϵ K, kᵤ denotes the u^{th} | | shipment kᵤ. |
| | shipment of the k^{th} commodity | | |
| | (u ϵ U ⊆ [symbol] ). | | |
| D(kᵤ) | The destination vertex of | EATₖᵤ | The Earliest Arrival Time |
| | commodity shipment kᵤ. | | (EAT) of a commodity |
| | | | shipment at its origin, O(kᵤ). |
| LDTₖᵤ | The Latest Delivery Time | Dₗ^{k} | The demand for a commodity |
| | (LDT) of a commodity | | unit to unit at an origin or |
| | its destination, D (kᵤ). | | destination vertex l ϵ V[G]. |
| cᵢₕⱼ^{ku} | The per commodity unit cost | uᵢₕⱼ | The total capacity of an arc h, |
| | to use arc h. | | expressed in number of |
| | | | commodity units. |
| uᵢₕⱼ^{ku} | The per-commodity capacity | sᵢ | The service time at location |
| | of an arc h, expressed in | | vertex i. |
| | number of commodity units. | | |
| ttᵢₕⱼ | The travel time along an arc, | | |
| | expressed in simulation time | | |
| | minutes. | | |

Optimizer Output Variables (y_{A})

| | |
|---|---|
| xₕ^{ku} | Indicator variable, 1 if commodity unit kᵤ takes edge h. |
| yₕ^{ku} | The number of commodity units that flow across edge h. |
| xₗ^{ku} | Indicator variable, 1 if commodity unit kᵤ uses vertex l. |
| yₗ^{ku} | The number of commodity units that flow through vertex l. |
| P | A set of optimal paths for each commodity through Gₜᵣₐₙₛ, |
| | computed from previous output variables. |

Given the inputs shown in Table 3 above, the optimal network flow model seeks to find the schedule that minimizes the delay costs of shipments being delivered after the latest delivery time and the operating cost of travel of all shipments. The optimization formulation may be implemented using the Python bindings for the Gurobi Optimization Library (Gurobi Optimization 2015).

As described herein, this document discloses a simulation system or tool 500 for coupling of a simulation of the flow of commodities through a shipping port with an optimization engine 516 that redesigns routes and schedules to minimize the cost of disruptions to the port transportation system. The intent of this coupling is to enable AMSCs to understand the impact and effect of cyber-physical disruptions (via the simulation engine 514 of FIG. 5) while mitigating the effect of such disruptions in a manner that satisfies a given objective function—such as minimize cost and time (via the optimization engine 516).

FIG. 1 illustrates a sequential coupling scheme between an optimization engine 102 and co-simulation engine 104. A sequential coupling 106 runs the optimizer A engine 102 and queueing network B 108 in sequence. Atand event j, outputs from the multicommodity schedule optimizer (y_{A}) 110 are transformed via function A/B to inputs for the queueing system u_{B}. The queueing system simulates port operations until the time of event j+1 at which point the behavior trace and other outputs y_{B} will be transformed to inputs for the optimizer u_{A}. If j+1 is a disruption or mitigation event, module D will perturb some of these inputs (e.g., service time) according to a disruption, mitigation, or response/recovery model. More details about the input/output vectors and transformation functions are provided herein.

As shown in FIG. 1, a schedule of commodities is used to route information through a queueing network instantiated from graphical models of baseline operations. Unlike the optimization engine 516, the simulation engine 514 can capture the effects of stochastic behavior on the movement of commodities, as well as record resource utilization. The intent of the simulation engine 514 is to be able to look at the robustness of an optimal schedule with respect to stochastic behavior (and disruptions) as well as to understand the degree to which different optimal schedules (as there may be more than one) affect resource utilization within a shipping port.

As discussed in previous sections, the coupling scheme may depend upon a network model (G_{Trans}) 340 (see FIG. 3) to represent the Maritime Transportation System (MTS). Moreover, the approach also depends upon commodity shipment schedules (K) that detail when various types of commodities arrive at a port. Through extensive fieldwork with partner shipping ports, models of baseline operations within shipping ports as well as dependencies between these operations and Communications/IT systems have been encoded.

In some embodiments, the optimizer-simulator coupling 106 may require a network model. FIG. 3 illustrates dependencies between port automation systems and a simple transportation system or layer 706. The intent of this model is to provide a simple but practical analysis of how disruptions to a cyber service or resource may affect the MTS. Consider FIG. 3 as a layered network whose components are partitioned according to the Communications/IT (G_{Cyber}) 350, and Transportation (G_{Trans}) 340 Critical Infrastructure Sectors. The container operations model represented by (G_{Trans}) 340 was developed based upon fieldwork as well as a recent report on emerging automation technologies in container operations by the United States Department of Homeland Security (DHS) (DHS 2017).

While implementing the prototype, several lessons were learned and challenges discovered that are applicable to other embodiments. First, there may be multiple conditions of interest that would invoke recomputing optimal commodity shipment schedules. Although the example in the previous section focused on a threshold of road capacity being exceeded, another condition may include when a certain threshold of non-optimal commodity movements is exceeded.

Second, when the simulator forks to execute a new optimization cycle (corresponding to moving from iteration j to iteration j+1 in FIG. 1), a variety of states may be saved to implement the B/A transformation. An in-depth discussion of the B/A and A/B mappings is not provided herein.

Third, the simulation engine 514 discussed herein, in some embodiments, may be a link-based simulation engine and as such, provides queues at link entrances and exits. In general, looking at scalability of the simulation and optimization to larger graphs and sets of commodities is applicable to further embodiments of the simulation system or evaluation tool 500. In general, not all optimal schedules may be created alike as we observed different schedules that had different resource utilization profiles in the simulation engine 514.

The simulation engine-optimization engine 500 may determine at least one disruption simulation from the one or more disruption models 610 and a disruption context for each disruption simulation. The disruption context includes time, duration, subgraph affected, subnetwork affected, and the parameters and functions altered to simulate the disruption. These disruption models may be included within a threat database.

Referring back to FIGS. 6A and 6B, some of the possible disruptions or threats are shown. Such threats may be caused by human activity, while others may be natural disasters. The threats may disrupt physical resources, cyber resources, IT infrastructure resources, and may also extend outside of the immediate port area, to include the electrical grid and other power related infrastructure, water and waste transport, and the like. The threats or disruptions provide the capability to model various “what-if” scenarios to assist with disaster planning, training and exercise, prioritization of action, optimization, and risk management. As discussed above, the disruptions or threats may be defined within DHS Threat and Hazard Identification and Risk Assessment (THIRA framework).

Note that the dependencies encoded by edges from nodes in (G_{Cyber}) 350 to (G_{Trans}) 340 may be used by the disruptions module D (shown in FIG. 1) to model how latencies within cyber services affect service times within the transportation network. Latencies resulting from disruptions within the cyber domain may be modeled as random variables or constants whose values represent the time delay introduced by the compromise or failure of that service. In general, delays may range from minutes (e.g., latencies within the Terminal Operating System (TOS)), to days (e.g., ransomware).

For example, the attack on the Port of Antwerp from 2011-2013, in which organized crime was able to alter TOS entries to illegally smuggle drugs, would require a model of data integrity, not a model that introduces latencies. This could be achieved by altering data within the cyber layer to simulate its impact on the behavior of the transportation layer. Nonetheless, embodiments of the approach disclosed in this document are suitable for a wide variety of cyber-physical disruptions.

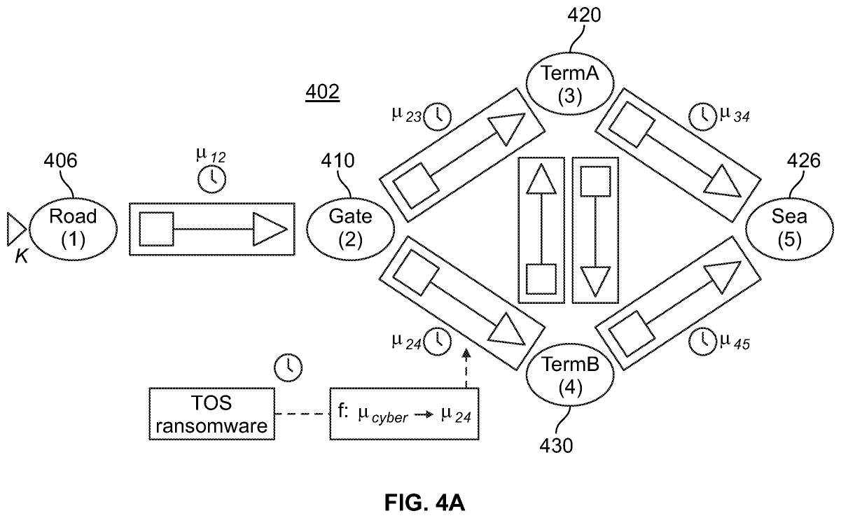

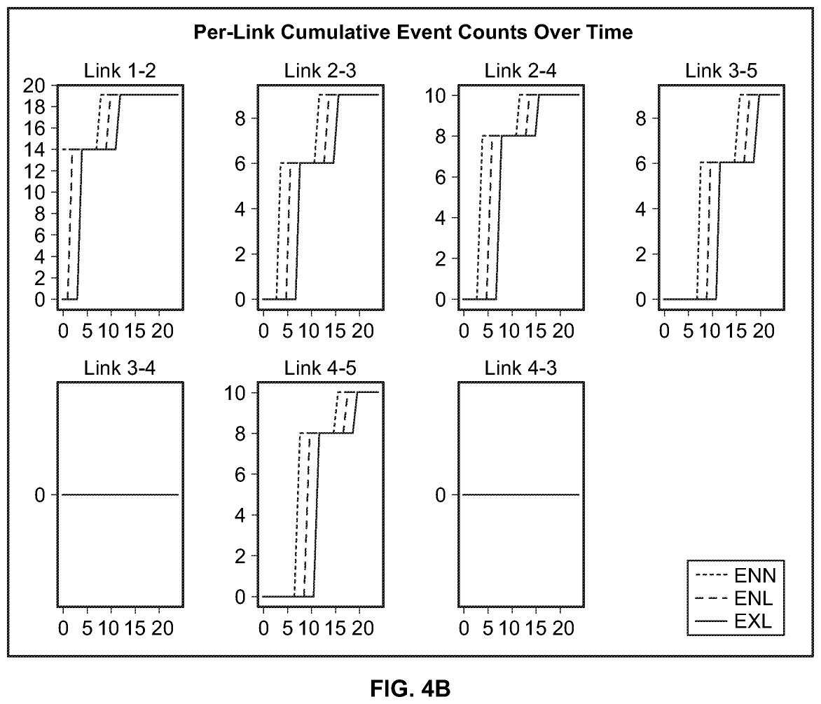

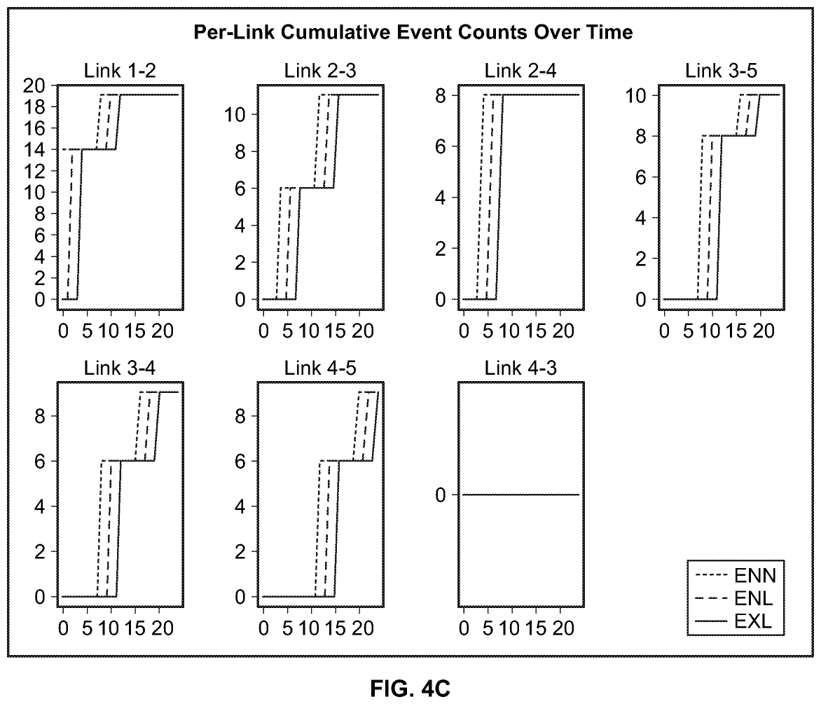

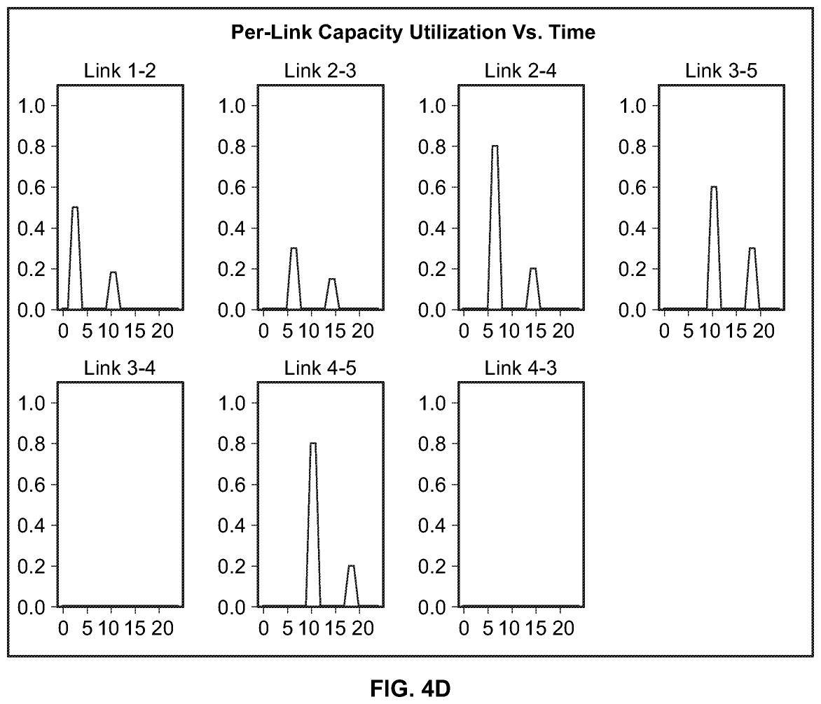

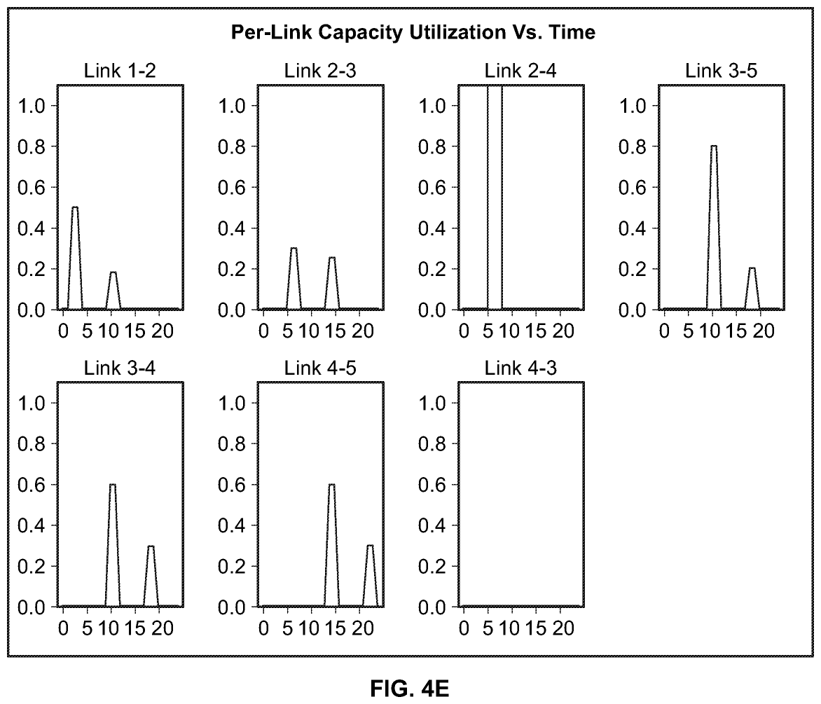

FIGS. 4A-4E show an example, which demonstrates the operation of a coupled optimizer-simulator discussed below. FIG. 4A shows a link-based queuing model 402 for an example scenario having five nodes, namely a main road (Road) 406, a shared Gate 410 to access either of two terminals (Gate), namely Terminals A 420 and terminal B 430 (TermA, TermB), and the commodity shipments' destination (Sea) 426. Trucks are assumed to carry a single twenty-foot equivalent (TEU) and arrive at the Road 406 according to the times provided by the optimal commodity schedule. Per-link travel times are given by a normal distribution B₁ whose mean is defined in terms of ttₗ for each link l∈A[G].

A disruption to the Gate's kiosk system could result in increased number of trucks queuing at the entrance of the road to Terminal B 430, for example. In this scenario (based on feedback from operators) a disruption at the lanes connecting Gate 410 to Terminal B 430 may cause an increase in traffic at the entrance 410 to that road. As a result, new trucks are effectively unable to use this road to reach the terminal. Such an occurrence may happen due to a lack of labor at a given time of day (e.g., lunchtime) or due to a disruption to gate operations caused by a ransomware attack, as shown in FIG. 4A. This example illustrates a scenario in which AMSC stakeholders could benefit from the ability to compute a new optimal route for commodities moving through the port following a disruption.

FIG. 4B shows the per-link cumulative event counts over time showing the flow of commodities along the links in the network. FIG. 4C shows the per-link cumulative event counts over time for a utilization threshold that has been exceeded. Commodities originally on link 2-4 that caused the congestion are rolled back and rescheduled to travel over link 2-3. FIG. 4D shows that at time t=6, the truck capacity threshold of 80% at link 2-4 is exceeded. In this case, the optimal paths were are recomputed. FIG. 4E shows the per-link capacity utilization after recomputing optimal paths at t=6 when the capacity utilization threshold of link 2-4 was exceeded.

For the results shown in FIGS. 4B-4E, a distribution is not used and instead travel times are deterministically set to ttₗ. The effect of stochastic behavior on optimality of paths is a possible area of future research as is the mapping from optimizer outputs to simulator inputs. The number of parallel servers c at the entrance and exit buffers for each link is given by the capacity of that link. Finally, the per-node queue length for entrance and exit buffers must sum to the total capacity of the link. Finally, the size of the calling population for each queue is bounded by the number of commodities K.

The simulation model runs as normal, however callbacks to the optimizer could occur under conditions that indicate the occurrence (or clearing) of spillover. In the former case, an example condition could be when the ratio of queued trucks to queue length in the link exceeds 80%. In the latter case, a condition for spillover clearing could be when the same ratio drops below some threshold. Other conditions, such as percent (%) of TEU arriving in an untimely fashion, could also trigger a call back to the optimizer.

As described above, FIG. 9A shows disruption to resources in a transportation network in a shipping port. The circles represent various nodes in the transportation network while the dashed lines show regions of transportation network through which the different operators need to move goods, in order to get paid. Such operators may include the trucking company, rail company, ocean carrier, port landlord, or port authority, terminal operator, and the like. A disruption can occur at a node or at an intersection, and may be shown as I1 (920), I2 (922), or I3 (924).

FIGS. 9B, 9C, and 9D show the effect of the disruption of on various stakeholders. FIG. 9B corresponds to a disruption for four stakeholders, namely operator 1, operator 2, operator 3, and the drayage company. The disruption whose effect is shown corresponds to the disruption at location I1.

FIG. 9C corresponds to a disruption at location I2 for the same four stakeholders, while FIG. 9D corresponds to a disruption at I3 for the same four stakeholders. The graphs shows how transport of the containers (TEU-twenty foot equivalent) is backlogged depending on where the disruption occurred, which may affect different stakeholders in different ways.

FIGS. 10 and 11 are related to FIG. 7 in that they show an example of the effects of a disruption outside of the shipping port in some embodiments. In FIG. 10, the disruption in the shipping port is shown to have an effect in a regional area, such as a transportation network (railroad, trucking, highway etc.), outside of the shipping port.

FIG. 11 shows multiple disruptions within the shipping port, such as a cyber disruption, which also affects a transportation network outside of the shipping port. FIGS. 10 and 11 show various visualizations that may be generated by the output engine 530 under control of the UI 524 of FIG. 5.

As discussed above, embodiments of the simulation system or evaluation tool are directly related to cyber threats and disruption, for example to a cyber layer or cyber network domain 710 having various infrastructure resources, such as, computers, servers, networks, interfaces, switches, controllers, and the like. A disruption to or reduction in capacity of any such resource may impact various other networks or layers, such as the transportation network or layer 706 for moving the commodities, whether within the shipping port or external to the shipping port.

In that regard, the increased dependence upon the cyber domain within shipping ports has led to greater efficiencies within commerce, but also has the potential to increase the attack surface of the MTS. Recent events such as the Maersk NotPetya incident, as well as historical events such as the Port of Antwerp hack from 2011-2013, underscore the need for an approach to evaluate the impact of a cyber-physical disruption or coordinated disruption to the MTS. This need is reflected within the USCG Cyber Strategy as well as H.R. 3101, which calls for ports to evaluate cyber-based risks as part of their Area Maritime Security Plans (AMSPs). The section below describes different types of disruptions specific to the cyber-physical network or layer that may occur within the MTS.

GNSS Jamming/Spoofing: The MTS depends upon the Global Navigation Satellite System (GNSS) for Position, Navigation, and Timing (PNT) services. These systems are used for a variety of purposes including timing for protection schemes in electrical power as well as navigation of vessels. GNSS jamming is the broadcast of a stronger signal that intentionally or unintentionally blocks or impacts a GNSS satellite signal. In contrast, GNSS spoofing is the broadcast of a GNSS signal at a slightly greater power, causing the receiver to lock on to the spoofed signal which can be used to transmit false PNT data.

Recent research in this space illustrates the susceptibility of shipping vessels to GNSS spoofing attacks. A notable demonstration was in 2017 in which students at the University of Texas at Austin were able to spoof civil GPS signals and direct the vessel on a new path.

Ransomware: Key port control and safety systems may be intentionally or unintentionally affected by ransomware. Once having been infected on a device; ransomware will encrypt data local to that device and possibly network-attached storage. A ransom is demanded by the threat actor for the data to be unencrypted. Even if the ransom is paid (e.g., in Bitcoin), the data may not be retrieved. Infection vectors include unpatched software (e.g., Java/Flash) and phishing campaigns.

Recently, the AP Mollar-Maersk shipment company was infected by the NotPetya ransomware. According to researchers at Kaspersky Lab, the high-level encryption routine was designed so that the attacker could not decrypt even if desired. As such, they concluded that this was not a true ransomware attack at all, but rather a “data wiper” masking as ransomware. The effect of this incident included large losses for Maersk (Forbes estimated losses at over $200 million) and this resulted in delays/disruptions that lasted for weeks.

Terminal Operating System (TOS) Attack: Given the number of actuators that depend upon sensor data and the increasing role of data mining, data integrity—the ability to maintain the accuracy/trustworthiness of data is vital. Within the MTS, Terminal Operating Systems (TOSs) monitor and manage the movement of containers in and out of one or more terminals. As such, these TOS depend upon the integrity of their data.

The consequences of not ensuring data integrity within TOS systems were illustrated by an incident that lasted from 2011-2013 at the Port of Antwerp in Belgium. Over the course of 2 years, organized drug traffickers were able to infiltrate computer networks (via keyloggers and spear phishing) and access information about the position of containers. The threat actors could then change the location and delivery times of containers with drugs in them (often mixed with bananas and timber). This kind of compromise could be used potentially by other threat actors to access other commodities such as Liquified Natural Gas (LNG) and other dangerous cargoes.

During running of the simulation system or evaluation tool 500, the simulation engine-optimization engine 512 may determine at least one mitigation simulation from the one or more mitigation models and a mitigation context for each mitigation simulation. The disruption mitigation context may include time, duration, subgraph location, and the parameters and functions altered to simulate the mitigation. Further the simulation engine-optimization engine 512 may determine at least one disruption response simulation from the one or more disruption response models and a disruption response context for each disruption response simulation. The disruption response context may include time, duration, subgraph location, and the parameters and functions altered to simulate the response.

When spillover occurs, the capacity of the corresponding link in the optimization (uᵢₕⱼ) is adjusted to reflect the decreased capacity and new routes computed. These new routes may be followed until the point that the simulation indicates that the spillover has cleared at which point the link capacity is restored in the optimizer and routes re-calculated. The goal is to provide the best set of actions possible given a disruption (intentional or unintentional) to a Captain of the Port (COTP), Port Security Manager, or other stakeholders within an AMSC.

Per-link cumulative event counts from routing commodity shipments according an optimal schedule are shown in FIG. 4B. Note that the capacity utilization of the road between Gate 2 and Terminal B exceeds the link capacity utilization threshold of 80% in FIG. 4D. This could be due to (or exacerbated by) a disruption as discussed above. If desired, stakeholders could compute an optimal response. In FIG. 4C, traffic on link 2-4 is rolled back to Gate 2 and routed via link 2-3, while capacity on link 2-4 is set to 0 to avoid congestion. In other embodiments, one could also allow the traffic on link 2-4 at the time of the disruption to clear out and subsequently adjust the capacity appropriately.

In some embodiments of the present invention, the simulation engine-optimization engine 512 may simulate the subject area based on the simulation model and the simulation context. As shown in FIG. 17, execution of simulation 1702 of the subject area may include: (i) execution of each disruption simulation based on its respective disruption context (disruption 1704 and disruption 1706); (ii) execution of each mitigation simulation based on its respective mitigation context (mitigation 1708 and mitigation 1710); and (iii) execution of each disruption response simulation based on its respective disruption response context (disruption response 1712 and disruption response 1714). In some embodiments, the simulation model may be viewed in detail separately for each domain. In some embodiments, an operator may provide or select the factors associated with the simulation, the disruption, the disruption mitigation, and the disruption response contexts.

In addition to the core modules, the simulation-optimization engine 512 may be enhanced with extension modules as shown in FIG. 5. For example, the simulation-optimization engine 512 may include modules that support Bayesian network-based approaches to interdependency analysis or algebraic approaches for implicit interdependency analysis.

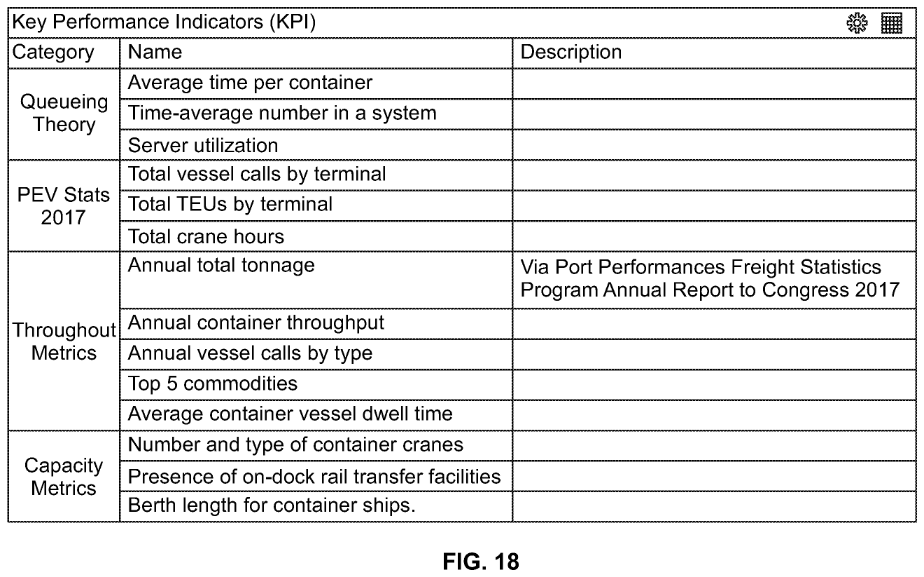

Analysis modules take outputs of the simulation-optimization engine 512 and compute metrics that may be used to measure the impact of a disruption in terms of key indicators of performance (KPI). These KPI may be stakeholder specific or over the entire system or a subsystem of the simulation/optimization context. FIG. 18 provides a table of possible KPI that may be computed by various analytic modules. Two examples of analytic modules include (1) KPI from traditional queueing theory and (2) KPI for analysis of economic impact to stakeholders.

There are several indicators of performance that we can use for the queueing system. These include (1) average time spent per container w(ŵ), (2) time-average number of containers in system (\hat{L}), (3) server utilization (ρ), and (4) system stability. These are well established within the field.

Practitioners using the simulation system or evaluation tool 500 need to understand and prioritize the effects of disruptions to shipping ports relative to their economic impact, in specific embodiments. The economic impact of a disruption depends on the context in which that disruption occurs. For example, a disruption's timing and duration may affect its impact. A disruption that affects operations when fewer commodities move through the port may have less economic impact to a port than a disruption during the busy season. The same disruption may affect stakeholders differently depending upon the source of their revenue.

For example, a disruption that affects the flow of high-value commodities may have a greater economic impact to sellers/buyers whose transaction depends upon the commodity value. In contrast, for stakeholders that are paid according to container volume, there may be no difference whether a disruption affects the flow a high value-or low-valued commodity. Benefits to researchers and stakeholders include the ability to reproduce economic analyses, to generate synthetic data to estimate parameters for economic models (e.g., Input/Output Models (I/O Models)), and to compute direct and indirect effects of disrupted commodity flows (including loss of bookings due to reputation loss following a cyberattack).

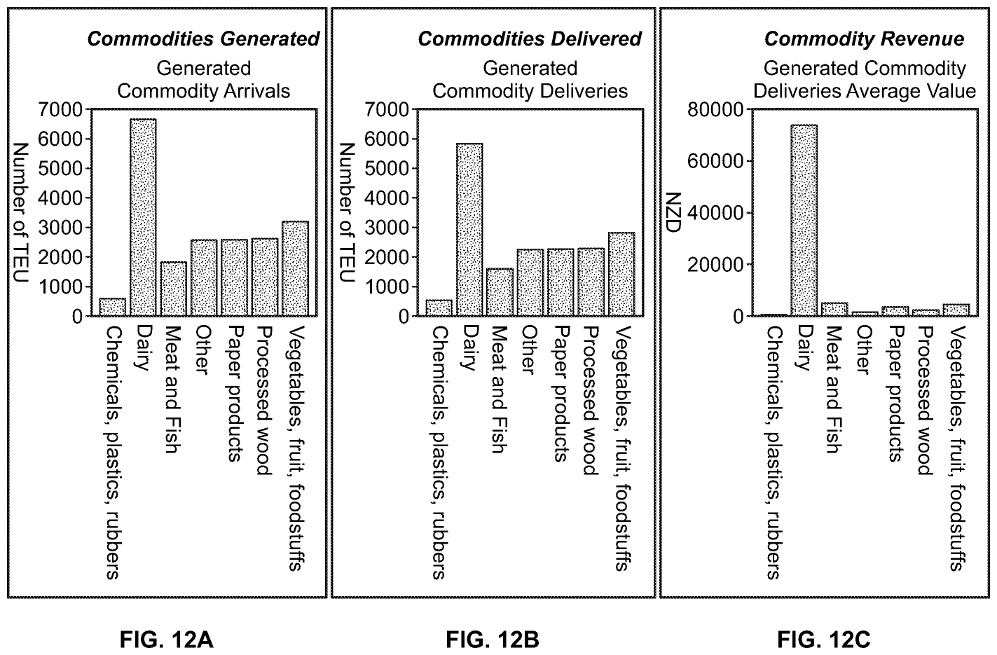

FIGS. 12A-12C are bar charts representing a gate disruption scenario for generated commodity arrivals, generated commodity delivery, and generated commodity deliveries average value. The graphs show the economic impact of a 10-day gate disruption in Q4 of FY2017, for example. By scheduling a disruption later in the quarter, one can see how the time delay caused by an outage of the Gate Operating System (GOS) affects commodity deliveries. In other related simulations in which the disruption was scheduled earlier, the average flow time of a TEU increased from a little over 3 days to up to 10 days over 5 runs. This increased flow time could result in shippers paying higher per-container fees to store containers in a yard and/or result in truck drivers losing revenue due to longer trip times, as occurred in the Maersk NotPetya incident.

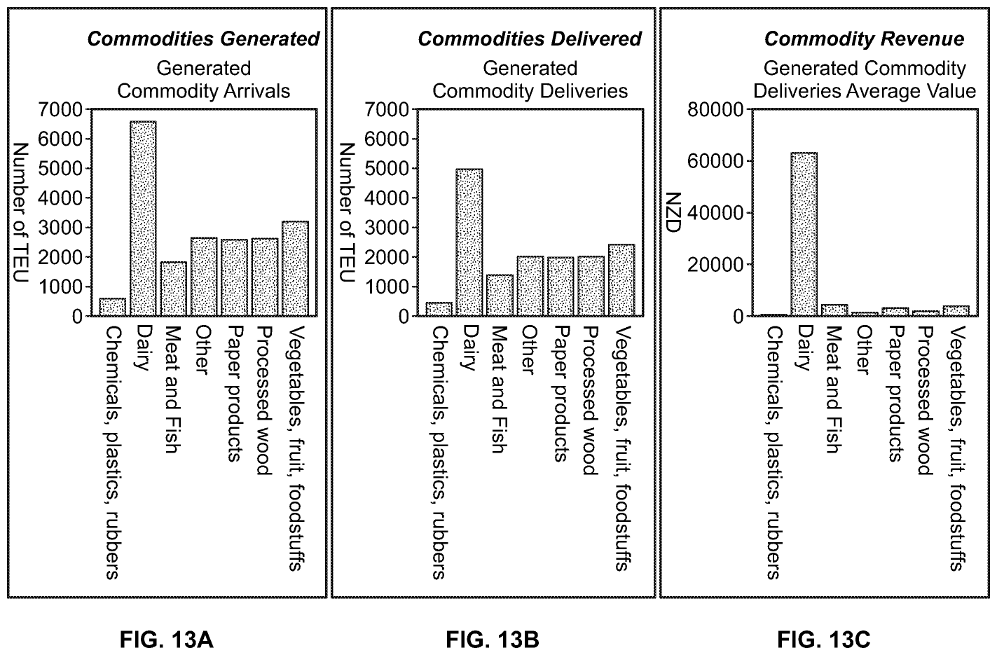

FIGS. 13A-13C are bar charts representing a gate disruption scenario for generated commodity arrivals, generated commodity delivery, and generated commodity deliveries average value, due to the impact of a hybrid or multiple disruptions in terms of commodities delivered. Note a significant reduction in the commodities that were successfully delivered compared to those that arrived.

The user interface 524 may be operatively coupled to the output engine 530 configured to provide a visual representation (visualizations) of the plurality of commodities flowing through the commodities transportation network, and may generate reports selectable through the user interface. Such visual representations may include graphs, charts, photographs, animations, and reports showing differences between a baseline scenario with no threats or resource disrupted, compared to a scenario with threat(s) providing disruption to one or more resources. Also shown are the number of commodities in the system, probability distribution of arrival/departure times, outliers, and the like.

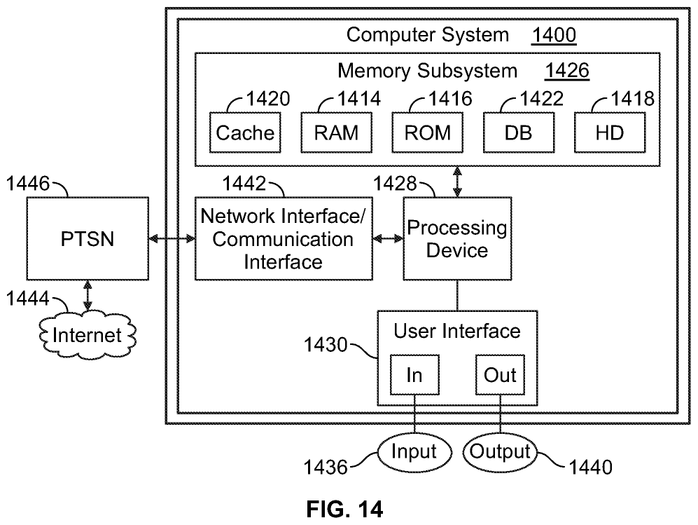

Turning now to FIG. 14, shown is a high-level hardware block diagram of a system computer 1400 that in some specific embodiments, may be used to execute software or logic to implement some components of the system for simulation and optimization of a commodities transportation network, embodiments of which are shown in FIGS. 1-13 and FIGS. 15-19. Further, such a system computer 1400 may be used in some embodiments, to execute software or logic to implement the simulation engine 514 and/or the optimization engine of the simulation system or evaluation tool 500.

The simulation system or evaluation tool 500 may be embodied as a system cooperating with computer hardware components and/or as computer-implemented methods. The system 500 may include a plurality of software modules or subsystems. The modules or subsystems, such as the simulation engine 514 or the optimization engine 516, may be implemented in hardware, software, firmware, or any combination of hardware, software, and firmware, and may or may not reside within a single physical or logical space. For example, the modules or subsystems referred to in this document and which may or may not be shown in the drawings, may be remotely located from each other and may be coupled by a communication network. The system 500 may be embodied as a system cooperating with computer hardware components and/or as computer-implemented methods, and may include a plurality of software modules or subsystems.

The computer 1400 may be a personal computer, work station, remote computer, server, and the like, and may include various hardware components, such as RAM 1414, ROM 1416, hard disk storage 1418, cache memory 1420, database storage 1422, and the like (also referred to as “memory subsystem 1426”). The computer 1400 may include any suitable processing device 1428, such as a computer, microprocessor, RISC processor (reduced instruction set computer), CISC processor (complex instruction set computer), mainframe computer, work station, single-chip computer, distributed processor, server, controller, micro-controller, discrete logic computer, and the like, as is known in the art. For example, the processing device 1428 may be an Intel Pentium® microprocessor, x86 compatible microprocessor, or equivalent device, and may be incorporated into a server, a personal computer, or any suitable computing platform.

The system 500 may also rely on co-processing/graphic devices such as graphical processing units (GPU's). GPU's allow the off-line learning to be heavily parallelized and make the process efficiently usable. GPU's may include, e.g., those that employ the NVIDIA CUDA architecture. The computer 1400 may include one or more GPU's, which may be part of or integrated into the computer or processor, or may be separate commercially-available components, chips, or entire boards.

The memory subsystem 1426 may include any suitable storage components, such as RAM, EPROM (electrically programmable ROM), flash memory, dynamic memory, static memory, FIFO (first-in, first-out) memory, LIFO (last-in, first-out) memory, circular memory, semiconductor memory, bubble memory, buffer memory, disk memory, optical memory, cache memory, and the like. Any suitable form of memory may be used, whether fixed storage on a magnetic medium, storage in a semiconductor device, or remote storage accessible through a communication link. A user or system interface 1430 may be coupled to the computer 1400 and may include various input devices 1436, such as switches selectable by the system manager and/or a keyboard. The user interface also may include suitable output devices 1440, such as an LCD display, a CRT, various LED indicators, a printer, and/or a speech output device, as is known in the art.

To facilitate communication between the computer 1400 and external sources, a communication interface 1442 may be operatively coupled to the computer system. The communication interface 1442 may be, for example, a local area network, such as an Ethernet network, intranet, Internet, or other suitable network 1444. The communication interface 1442 may also be connected to a public switched telephone network (PSTN) 1446 or POTS (plain old telephone system), which may facilitate communication via the Internet 1444. Any suitable commercially-available communication device or network may be used.

The logic, circuitry, and processing described above may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device.

The medium may be implemented as any device that contains, stores, communicates, propagates, or transports executable instructions for use by or in connection with an instruction executable system, apparatus, or device. Alternatively or additionally, the logic may be implemented as analog or digital logic using hardware, such as one or more integrated circuits, or one or more processors executing instructions; or in software in an application programming interface (API) or in a Dynamic Link Library (DLL), functions available in a shared memory or defined as local or remote procedure calls; or as a combination of hardware and software.

In other implementations, the logic may be represented in a signal or a propagated-signal medium. For example, the instructions that implement the logic of any given program may take the form of an electronic, magnetic, optical, electromagnetic, infrared, or other type of signal. The systems described above may receive such a signal at a communication interface, such as an optical fiber interface, antenna, or other analog or digital signal interface, recover the instructions from the signal, store them in a machine-readable memory, and/or execute them with a processor.

The systems may include additional or different logic and may be implemented in many different ways. A processor may be implemented as a controller, microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instructions may be parts of a single program, separate programs, or distributed across several memories and processors.

Embodiments of the simulation system or evaluation tool 500 described with respect to FIGS. 1-19 may simultaneously simulate and optimize all layers, such as the transportation layer 706 of a shipping port, an electrical layer or grid 708, a cyber-physical layer 710 and the like. Note that a transportation layer 706 may also be external to the shipping port, such as a transportation layer representing roads, highways, bridges, rail system, public transit, and the like. Although FIG. 7 particularly shows a pictorial representation of an embodiment of the simulation system or evaluation tool 500, this embodiment is not limited to a transportation layer or network of a shipping port environment.

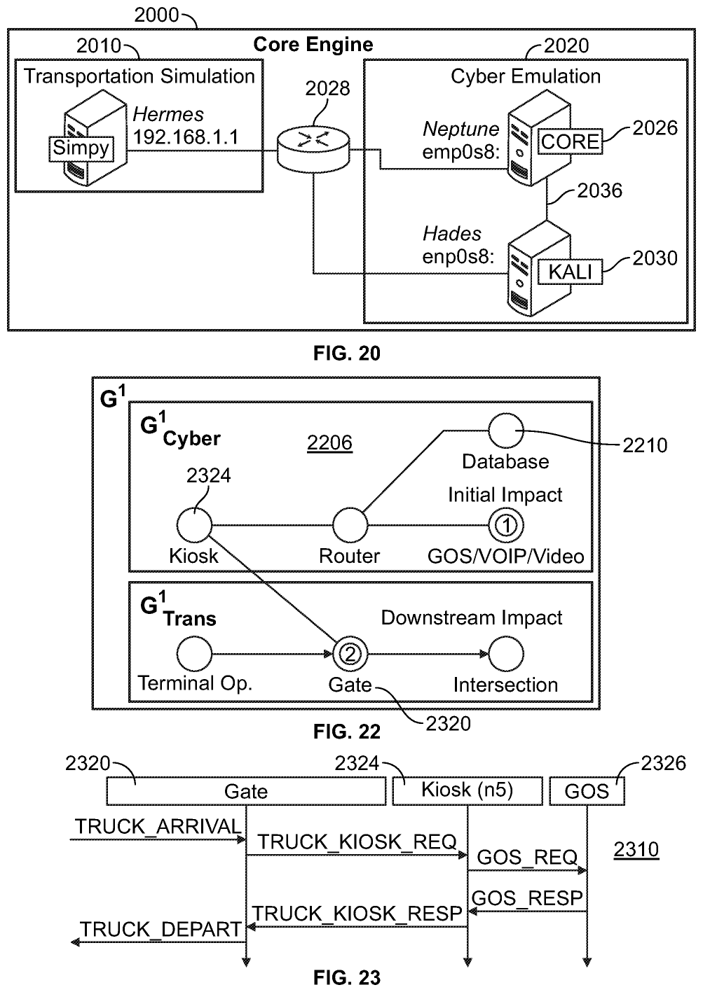

In that regard, FIGS. 20-26 are directed to another embodiment, which may rely on various aspects and features of the embodiments of FIGS. 1-19, but which are directed to a system 2000 (see FIG. 20) for simulation of network flow in a first domain network based on emulation of disruptions in a second domain network.

In that regard, FIG. 7, which is applicable to the embodiment of FIGS. 20-26, is instructional to show the interrelationship between seemingly different networks, such as between the transport network or layer 706 and the cyber or cyber-physical network or layer 710. However, such seemingly different networks may be interrelated and have various interdependencies such that an action or disruption in one network may have an effect on the other. The following description will provide detail and examples regarding disruption of resources in one network, such as the cyber network 710, and how that translates into an adverse effect or degradation in another interrelated network, such as the transportation network 706, for example, in a shipping port.

With respect to FIG. 7 and multilayered networks in a shipping port, such shipping ports are a nexus of critical infrastructure systems, which include multiple stakeholder systems, each providing a business function which contributes to the overall correct operation of the MTS. Given that such systems are designed by several stakeholders over time with respect to silos of specialization, a formalism may be used that lends itself to iterative composition of new systems, where FIG. 7 in particular illustrates a high-level pictorial representation of the types of infrastructure networks upon which shipping port business processes depend.

In that regard, FIG. 7 may represent a multilayer network as a quadruple, as follows:

M=(V_{M}, E_{M}, V, L) in which:

V_{M} is a set of node-layer tuples that indicate the layer on which a node exists.

E_{M} is the set of directed edges that connect nodes within and across layers.

V is the set of nodes in the network, which may exist in multiple layers as indicated by V_{M}; and

L is a set of elementary layers.

In embodiments of the invention, the function of multilayer networks may be modeled as flows of commodities from an origin node to a destination node. In the case of transportation network layers 706 (e.g. of type G_{Trans} 340), commodities correspond to vessels moving through the port's water-side operations and TEU carrying goods through the port's land-side operations. Moreover, in the case of electrical power networks and jet fuel/gasoline pipelines, multicommodity network flows also serve as a useful abstraction. For Communications/IT networks and other cyber resources, the flow of information may be represented (perhaps tied to a specific service) in the form of packets from a source to a destination.

FIG. 20 in conjunction with FIG. 7, illustrate operational aspects of the system 2000 for simulation of network flow in a first domain network, such as a transportation network 706, based on emulation of disruptions in a second domain network, such as a cyber network or layer 710, hereafter also referred to as the system for simulation of network flow 2000. FIG. 20 illustrates an exemplary architecture that supports the framework for the multilayered representation of FIG. 7 as it applies to the system for simulation of network flow 2000.

The system for simulation of network flow 2000 (which may be a virtual network) may include a simulation engine 2010, which in some embodiments simulates the transportation domain 706, and an emulation engine 2020, which in some embodiment may include a component referred to as a CORE component 2026, which will be described in greater detail below.

The system for simulation of network flow 2000 may include a virtual network 2000 whose IP address subnets are defined according to infrastructure sector. The hosts on the network may include a machine to run the transportation simulation, one or more routers 2028, and the emulation engine 2020 for emulation of the cyber domain or communications/IT network, in this specific example. Also included is a component referred to as KALI 2030, which may be an instance of Kali Linux. When dynamically coupled, event handlers may translate events among the cyber domain or layer 710 and the transportation domain or layer 706, in embodiments of FIGS. 20-26.

Note that some virtualized machines in the port network may run on the CORE machine 2026 but hardware, such as adversary machines or domain-specific machines that can't be virtualized may be connected as shown in 2030 (KALI). Note that KALI 2030 is an example of a machine that can be connected to CORE 2026. Other resources that can't be virtualized could also be integrated in this manner. However, the Kali Linux distribution could be virtualized in a virtual machine.

The simulation engine 2010 may simulate the transportation domain 706 in conjunction with the emulation engine 2020, which may emulate the cyber domain 710, which emulation engine 2020 may be on another network or may be a self-contained machine or component, whether a physical machine or a virtual machine. The emulation engine 2020 may be configured to accurately to reflect, to the extent possible, the actual real-world structure or arrangement of cyber components in the shipping port, for example.

The component labeled as KALI 2030 may be a plug-in that simulates one or more selected disruptions (e.g., an adversary machine). The disruptions may be based on a description of threats, and such disruptions may be arranged, via the emulation engine 2020, to activate at selectable times and in a predetermined sequence. The various disruptions or threat descriptions of FIGS. 6A-6B may be applicable to this embodiment.

Note that actual cyber-physical components or hardware to be emulated may be physically plugged into the system 2000 via an ethernet cable, or such components or hardware to be virtual. The reference line 2036 coupling the CORE component 2026 and the KALI component 2030 may represent the adversary or disruption traffic, and may be implemented as an interface that permits the cyper-emulation or the CORE component 2026 to communication with the adversary machine (KALI) 2030.

If a cyber component to be emulated is virtual, an interface program may facilitate execution and running of the cyber asset or resource. For example, in one embodiment, a plurality of cyber hardware or software devices may be coupled to the emulation engine 2020 and controlled in real-time or near real-time to facilitate real-world emulation, and hence may provide a real-world response to various degradations or disruptions. Each cyber asset or resource may be a virtual machine designed to function identically or in near-identical operation as the actual cyber asset or resource being emulated.

The simulation engine 2010 may be based on an open source library entitled SimPy (copyright 2020, Version 3.11.6), written in the Python programming language, which is an open-source software platform, which may be used to create discrete-event simulations. In some embodiments, this library and simulation platform or package may be used by the simulation engine 2010 to model or simulate the transportation network 706. Further publicly available details about the SymPy simulation library may be found at the following web link: https://simply.readthedocs.io/en/latest/. However, other simulation platforms may be used, such as other commercially available simulation platforms.

The emulation engine 2020 may be based on CORE (Common Open Research Emulator). In some embodiments, this emulation platform or package may be used by or may be the emulation engine 2020 to emulate the cyber network, for example. CORE 2026 was originally developed by Boeing Corp. and was extended in scope and sophistication by the U.S. Naval Research Laboratory. Further publicly available details about CORE may be found at following web link: https://www.nrl.navy.mil/itd/ncs/products/core. However, other emulation platforms may be used, such as commercially available emulation platforms and packages (e.g.Docker).

Further, an open source software library referred to as NetworkX may be used in some embodiments to provide graphical output and/or represent the transportation network topology. The output engine of 530 of FIG. 5 may be used for this purpose. NetworkX was developed at Los Alamos National Laboratories. NetworkX is a Python package for the creation, manipulation, and study of the structure, dynamics, and functions of complex networks. Further publicly available details about NetworkX may be found at following web link: https://networkx.github.io.

Examples of emulated virtual machines, may include a virtual machine or profile for a cyber resource or asset for every type of device modeled in the cyber network or layer 710, such as for example, a web server, a database server, and a gate kiosk and the associated GOS (Gate Operating System). In some embodiments the TOS (Terminal Operating System) may be separate and apart from the GOS, while in other embodiments, the TOS and the GOS may be integrated into a single system, with the GOS generally considered to be a subset or further portion of the TOS. This may depend on the real-world configuration of the two systems in the actual shipping port for which this simulation and emulation are run.

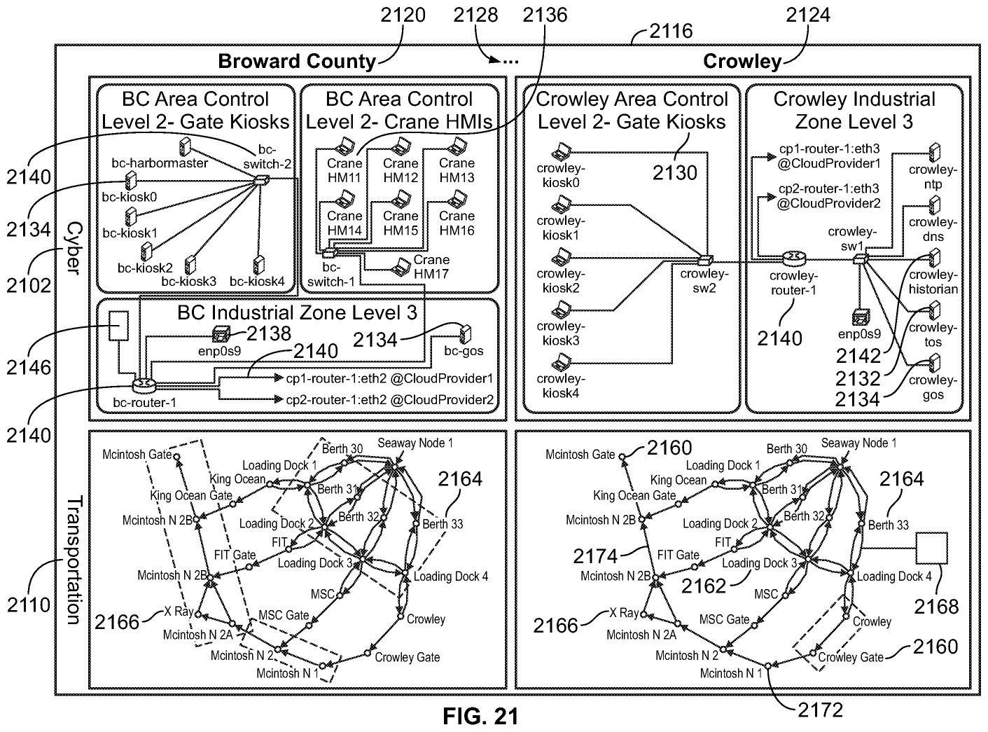

In FIG. 21, cyber-critical infrastructure (CI) or sector 2102 is shown in row 1 (panel 1), while transportation-critical infrastructure (CI) or sector 2110 is shown in row 2 (panel 2), in a shipping port 2116 for example. The columns represent a plurality of stakeholders or entities responsible for certain infrastructure in the shipping port 2116. In this example, only two such stakeholders as shown for purposes of clarity, although many stakeholders may be present. For example, column 1 represents a stakeholder for Broward County 2120, while the second or last column represents a stakeholder for Crowley 2124. Although only two stakeholders are shown, the series of dots 2128 between columns indicates that additional stakeholders may be represented.

Assets or resources in the cyber CI 2102 are shown in pictorial format, and may include for example, but are not limited to: emulated computer networks 2130, TOS (Terminal Operating System) 2132, GOS (Gate Operating System) 2134, crane HMI's 2136, IT equipment 2138, routers 2140, databases 2142, VOIP networks 2144, video and camera systems 2146, other communication systems, and the like.

Assets or resources in the transportation CI 2110 are shown in pictorial format as well, and may include for example, but are not limited to: gates or gate kiosks 2160, loading docks 2162, births 2164, X-ray stations 2166, gantry cranes 2168, straddles 2170, roads 2172, rail systems, trucks, transports, other vehicles 2174, and the like.

Simulation allows evaluation of the impact of a disruption in terms of measures of performance. With the adoption of information technologies and automation systems, there is more randomness in the overall system in terms of adaptive routing of commodities and as such, like many complex systems, a closed form solution to compute routes is difficult to achieve.

With respect to the simulation engine 2110 of FIG. 20, given a network of type G_{Trans} (340 see FIG. 3), we instantiate a queueing network in which each node and edge in G_{Trans} may be transformed into a queueing system with parameters for capacity, service time, queue length, and queueing discipline as defined via Kendall's notation. Each queueing system may then be connected in a network in a manner consistent with the topology of G_{Trans}. In some embodiments, the results of such a queuing system may be derived from real-world vessel schedules and Bills of Lading (PIERS dataset). For example, FIG. 21 illustrates the real-world network topology for the Port Everglades shipping port in Florida.

To understand how various disruptions affect the ability of port stakeholders 2120, 2124 to provide their services (and thereby generate revenue), the system for simulation of network flow 2000 considers which measures of stakeholder performance the system 2000 should compute. In this manner, resilience can be measured as the ability for a stakeholder to continue to provide a business-critical function given a particular disruption. Of course, there are many possible measures of stakeholder performance for a shipping port, only some of which may be specifically addressed herein.

For example, the Bureau of Transportation Statistics (BTS), in its report entitled “Port Performance Freight Statistics Program Annual Report to Congress,” uses measures of port throughput and capacity. In addition, service contracts among port stakeholders, such as those defined in 46 C.F.R § 535.104, may express performance in terms of volumes of cargo, transit time, and other features.

Thus, the system 2000 for simulation of network flow in a first domain, such as a transportation layer 706, may be based on emulation of disruptions in a second domain network, such as the cyber or cyber-physical layer 710, according to one embodiment. As described below in further detail, the simulation engine 2010 may generate a network flow model of the first domain network based on a plurality of resources available in a first domain network 706 corresponding to a first subject area, which resources, in part, have been described above. Further, the emulation engine 2020 may emulate the second domain network, such as the cyber domain 710, which corresponds the plurality of resources also described above.

As is a continuing theme throughout the various embodiments, a disruption 610 corresponding to at least one resource in the cyber domain or network 710 is received by the emulation engine 2020 to model the network flow of the resources in the cyber domain 710. Moreover, the disruption 610 in the cyber domain network 710 may be calculated or determined and its affect, reflected in the network flow model of the transportation or first domain network 706.

As mentioned above, the framework described in the embodiments of FIGS. 20-26 permits translation of the impact of a disruption to the cyber domain 710 or communications/IT networks owned by different stakeholders, for example, into effects on the function of the transportation domain, for example, in the maritime transportation system (MTS). FIGS. 22 and 23 illustrate an embodiment showing the impact of network degradation on commodity flows through the shipping port 2116. General disruption patterns may include events that indirectly (or directly) affect the service time at a transportation node by reducing or degrading the availability of information services upon which the transportation node depends. For example, in order to process a vehicle, a gate's service time may be a combination of time from physical processing and the time taken to retrieve and provide information from and/or to a database of the gate operating system (GOS) 2134. As this physical processing time becomes smaller, smaller variations to information retrieval/processing time tend to dominate the service time. This may be further magnified by the number of connections made to the IT system via a transportation node when servicing a vessel, container, or vehicle.

For example, the representation of FIG. 23, illustrates one connection in the form of a UML sequence diagram 2310 for the process of a truck arriving at a gate 2160, 2320. The gate 2320, a kiosk 2324, and a gate operating system 2326, 2134 (GOS) represent critical infrastructure. The threshold, which may be based on explicit parameters, or values, or human experience and expertise, may indicate a cutoff point after which an operator may switch to a manual process to mitigate the disruption. Specifically, FIG. 23 illustrates the process by which vehicles move through the gate kiosk 2324. In order for a truck to exit a container yard, the driver must follow a particular procedure, which prior to automation, could take as long as 15 minutes. This procedure requires exchanging information between the gate attendant and driver (e.g. checking a drivers ID, verifying the booking number) to ensure that the cargo cleared customers and the driver was authorized. With automation, the rate of flow of information between driver and gate worker has greatly increased and so the exit rate of drivers has also increased.

As a consequence, as automation drives increasing efficiencies within the MTS for ports to remain competitive, service times for business processes may increasingly be dominated by information transactions. This means that variations for service times in the cyber layer 710 may have a greater impact on overall service times for MTS business functions at a given location. In that regard, when a truck arrives at gate 2160 in transportation simulation, the distribution of time that it takes to get the requested information back to the gate kiosk 2324 from the GOS 2134, 2326 under normal and disruptive conditions may be known empirically. Such distribution may be based on observed data. Two simulation modes of the transportation domain 706 may be possible using the simulation engine 2010, according to embodiments of the system 2000:

Mode 1. Pre-running the transportation simulation using the simulation engine 2010 and causing the disruption in the cyber domain, which provides a first order approximation of the disruption in the cyber domain, which then creates the parameters for the changes to the transportation simulation.

Mode 2. In this mode, the transportation simulation using the simulation engine 2010 and the cyber emulation using the emulation engine 202 may run simultaneously and realistic communication is occurring between each system. The transportation simulation engine 2010 may issue an actual request to the cyber emulation engine 2020, meaning actual packets will be sent as a result of the truck arrival event in the transportation simulation engine, which would indicate that a truck has arrived at the gate 2320, and that a request should be generated to the GOS 2326. In response to the actual request, the cyber emulation running on the emulation engine 2020 or CORE component 2026, may translate that request into the required information to the gate, and send that information back to the transportation simulation so that the transportation simulation will go forward and execute. This mode is more accurate and is closer to real-world processes than the first mode described above.

FIG. 22 illustrates a general multilayer threat pattern to show how a degraded network 2206 used to access a database 2210 (e.g. GOS 2326) in the cyber layer or domain 710 may lead to a downstream, secondary effect in the transportation system or layer 706. This disruption, represented as a network motif, is enabled through a cross-infrastructure dependency between the kiosk 2324 and the gate 2320. Degradation of the network's quality of service may also affect other services at gates such as the GOS 2326, VOIP and/or video services (for OCR). There is a dependency between the kiosk and the gate resulting in a downstream impact in the transportation layer.

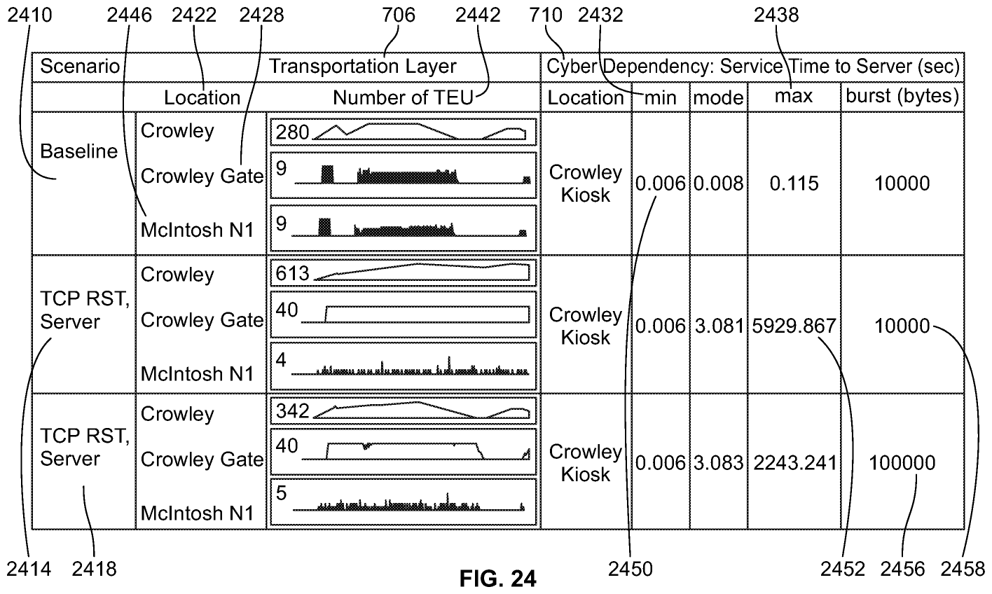

FIG. 24 illustrates a specific example of disruption in the cyber layer 710, which affects the transportation layer 706, and provides expanded details with respect to the disruption shown in FIGS. 22 and 23. FIG. 24 shows three scenarios, namely a baseline or normal operation of row 1 (2410), a first disruption shown by row 2 (2414), which represents a TCP Reset attack (also referred to as a Denial of Service (DOS) attack against the GOS to which the gate kiosk communicates, and another TCP Reset attack disruption shown in row 3 (2418), but using cyber resources having a higher burst capacity.

As shown under the “Location” heading 2422, the asset of interest in the transportation layer is the Crowley Gate 2428, and there is shown a dependency between the Crowley gate and Crowley kiosk. There exist a specific service time for the Crowley gate, meaning the time from making a request at the gate kiosk to receiving the information back from the gate server or operating system (GOS). For example, in a baseline operation 2110, the minimum time delay 2432 is 0.006 seconds while the maximum time delay 2438 is about 0.115 seconds. At the transportation layer 706, the number of TEU's (20 foot equivalent units) 2442 is shown entering the Crowley gate 2428, which TEUs flow out of the gate to the McIntosh N1 roadway 2446 to which the Crowley gate 2428 leads.

FIG. 24 shows that based on normal conditions, the time delay from the gate kiosk request until the require information is received is almost instantaneous (0.006 seconds) 2450. However, based on a DOS attack on the GOS 2326, the time delay from the gate kiosk request until the require information is received increases to over 90 minutes (5929 seconds) 2452.

Row 3 (2418) of FIG. 24 shows the difference in the response when the GOS is configured to be able to absorb a burst of 100,000 bytes 2456 (Row 3) rather than only 10,000 bytes 2458, as shown in row 2 (2414). The burst capacity 2456, 2458 directly influences the GOS response to the DOS attack. Thus, this example shows how variation of a critical parameter in the cyber layer 710 translates directly into a variation in the impact in the transportation layer 706, namely, the number of TEUs 2442 that can transit the gate in a given amount of time.

The results shown in FIG. 24 may illustrate the impact of a TCP RST attack on a Gate Operating System webserver for one of the terminal operator's gates. In the baseline scenario, we see very fast service times. However, when the TCP RST attack was run, the maximum service time shifted greatly and resulted in waiting times of up to approximately 1.5 hours. The transportation simulation assumes one connection and no failover to a purely-manual operation. In this example, the disrupted scenario occurs for a 3 day period. Although not crystal clear in FIG. 24, the impact to the gate from the disruption increases from 9 TEU (4-5 trucks carrying 2 TEU each) to 40 TEU (20 trucks). The traffic backlog is never cleared in the case where the number of traffic that the server can handle at once is lower (10000 byte burst). However, when this parameter is increased, the traffic is cleared and this suggests a possible mitigation action in the cyber domain that affects physical traffic flows. The upstream impact to Crowley's container yard shows a large backlog of TEU and an undersupply of TEU downstream at the traffic intersection.

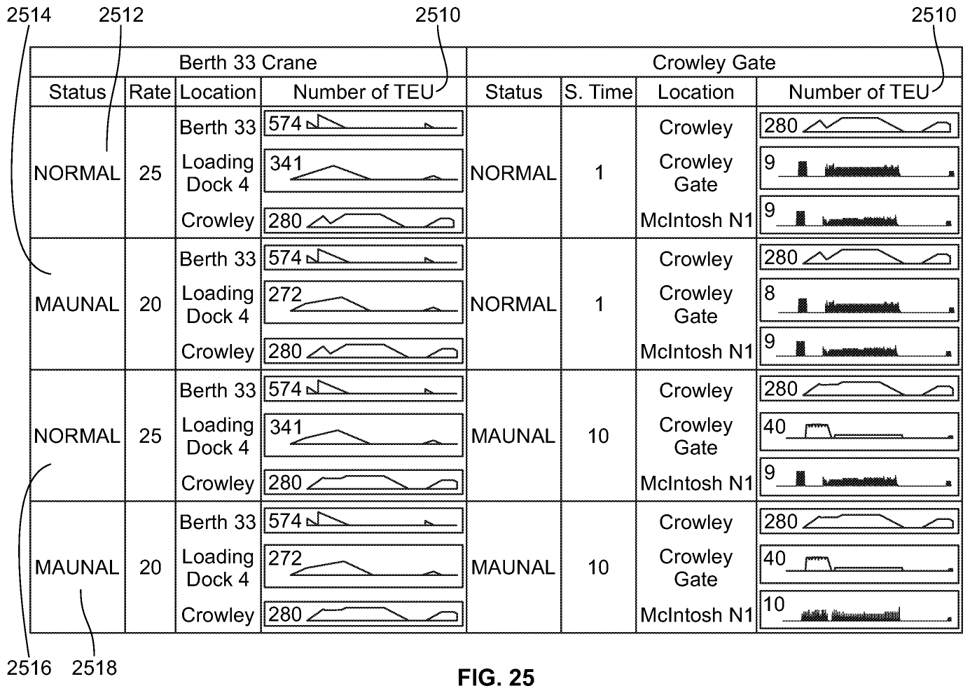

FIG. 25 is conceptually similar to FIG. 24 but shows how the QOS (quality of service) is degraded in the cyber domain with respect to increased jitter and packet loss in the communications network, such as VOIP and video. In this figure, the impact of disruptions to VOIP and video on the shipping port operations is shown with respect to the number of TEU's handled 2510. The graphs represent four cases, shown in row 1 (2512), row 2 (2514), row 3 (2516), and row 4 (2518). FIG. 25 illustrates the impact of a 1-day disruption to either a terminal operator's gate or crane (or both). The disruption occurs on day 2 of a 3-day simulation run. Each row shows the flow of TEU imported from a berth through a container yard and to a traffic intersection. When the crane rate changed from 25 moves per hour to 20, one can see a different rate of offload in Loading Dock 4. When the gate is disrupted, one can see a buildup at Crowley gate and the effects of backlog back to Loading Dock 4. Finally, the last row of the table illustrates the impact of simultaneous disruption for 1 day.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

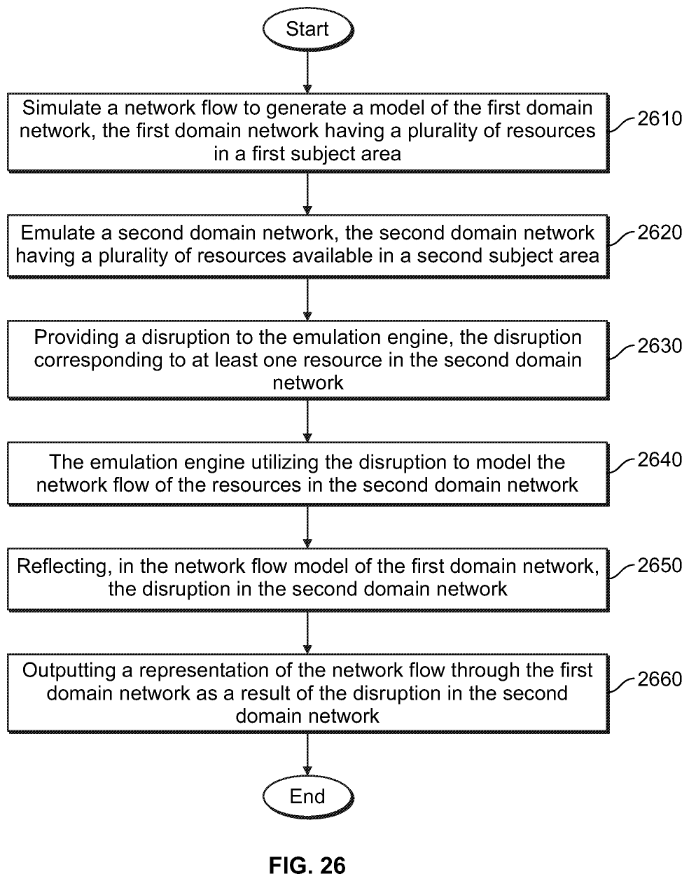

FIG. 26 is a simplified flowchart illustrating the steps that may be taken by the system for simulation of network flow 2000. In step 2610, the simulation engine 2010 may simulate a network flow to generate a model of the first domain network, such as the transportation domain, where the first domain network may include a plurality of resources in a first subject area.

In step 2620, the emulation engine 2020 may emulate a second domain network, such as the cyber or cyber-physical domain, where the second domain network may include a plurality of resources available in a second subject area.

Next, in step 2630, a disruption may be provided to the emulation engine 2020, where the disruption may correspond to at least one resource in the second domain network. The disruption may be in the form of a threat description.

In step 2640, the emulation engine 2020 may utilize the disruption to model the network flow of the resources in the second domain network.

Next, in step 2650, the system may reflect, in the network flow model of the first domain network, the disruption emulated in the second domain network.

In step 2660, the system may utilize the output engine 530 to output a representation of the network flow through the first domain network as a result of the disruption in the second domain network.

Note that the high-level hardware block diagram of a system computer 1400 in FIG. 14 may be applicable to the embodiments of FIGS. 20-26 as well, and may represent all of or portions of the simulation engine 2010, the emulation engine 2020, CORE 2026, or KALI 2030, and other computing components, and may be used to execute software or logic to implement some components of the system for simulation of network flow 2000.

While the present invention is susceptible to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention as defined by the embodiments above and the claims below. Reference should therefore be made to the embodiments above and claims below for interpreting the scope of the invention.

What is claimed is:

1. A simulation system configured to model network flow through a domain network, the system comprising:
a user interface configured to create a network flow model of a domain network corresponding to a subject area;
a network flow model based on a plurality of resources available in the subject area, wherein the plurality of resources facilitate a network flow through the domain network;
a simulation engine in communication with the user interface, configured to simulate the network flow through the domain network based on the network flow model;
an optimization engine in operative communication with the simulation engine, configured to evaluate and minimize an impact of one or more disruptions to one or more of the plurality of resources;
a plurality of threat descriptions selectable through the user interface, wherein one or more of the selected threats provided to the simulation engine to represent a disruption of one or more of the plurality of resources; and
an output engine configured to provide a representation of the network flow through the domain network and generate reports selectable through the user interface.

2. The system according to claim 1, wherein the optimization engine determines an optimal routing path for the network flow based on the disruption of the one or more of the plurality of resources.

3. The system according to claim 1, wherein the disruption of the one or more of the plurality of resources is defined within a threat and hazard identification and risk assessment framework.

4. The system according to claim 1, wherein the simulation engine and the optimization engine are iteratively invoked by a trigger event related to the disruption of the one or more of the plurality of resources, so as to recompute a network path through the domain network that minimizes the impact of the disruption to the network flow.

5. The system according to claim 1, wherein the resource is a physical resource, including at least one of a ship, a vessel, a gantry crane, an automated straddle carrier, a transit vehicle, a lifting vehicle, a gate, a road, railroad tracks, and a dock.

6. The system according to claim 1, wherein the resource is a cyber resource, including at least one of a server, computer, controller, computer network, a wireless network, a communications network, and a terminal operating system.

7. The system according to claim 1, wherein inputs to the simulation engine include:
a representation of the network flow model, wherein the domain network corresponds to a commodities transportation network and the network flow corresponds to a plurality of commodities;
an identification of the plurality of commodities to be routed through the commodities transportation network;
an entry and exit node within the transportation network for each commodity; and
wherein each path traversed is represented by a plurality of links, where each link is defined as connected between nodes.

8. The system according to claim 7, wherein each node and link includes an associated queueing model.

9. The system according to claim 7, wherein each commodity is a shipping container or a twenty foot equivalent (TEU).

10. The system according to claim 7, wherein an altered state of the commodities transportation network corresponds to a change in capability of one or more of the resources.

11. The evaluation tool according to claim 10, wherein the impact of one or more alterations to the commodities transportation network corresponds to a functional or economic impact of the change in capability of one or more of the resources.

12. The system according to claim 7, wherein the impact of one or more alterations to the transportation system via one or more of the resources corresponds to a change in transporting the commodities.

13. The system according to claim 1, further including a threat database configured to contain the plurality of threat descriptions.

14. The system according to claim 1, further comprising:
a plurality of mitigation action descriptions selectable through the user interface;
wherein one or more of the selected mitigation actions are provided to the simulation engine to represent the mitigation of the one or more disruptions; and
wherein the simulation engine is further configured to simulate the network flow through the domain network based on the one or more mitigation actions.

15. The system according to claim 1, further comprising:
a plurality of response action descriptions selectable through the user interface;
wherein one or more of the selected response actions are provided to the simulation engine to represent a response to the one or more disruptions; and
wherein the simulation engine is further configured to simulate the network flow through the domain network based on the one or more selected response actions.

16. A system for simulation of network flow in a first domain network based on emulation of disruptions in a second domain network, the system comprising:
a simulation engine configured to generate a network flow model of the first domain network, the network flow model based on a plurality of resources available in a first domain network corresponding to a first subject area;
an emulation engine configured to emulate the second domain network, the second domain network having a plurality of resources available in a second subject area;
a disruption corresponding to at least one resource in the second domain network, the disruption configured to be received by the emulation engine, the emulation engine utilizing the disruption to model the network flow of the resources in the second domain network;
wherein the disruption in the second domain network is reflected in the network flow model of the first domain network; and
an output engine configured to provide a representation of the network flow through the first domain network as a result of the disruption in the second domain network.

17. The system of claim 16, wherein the first domain network is a transportation domain and the second domain network is a cyber or cyber-physical domain.

18. The system of claim 16, wherein the simulation engine models network flow of a plurality of commodities in the first domain network.

19. The system of claim 16, further including a user interface configured to create the network flow model of the first domain network.

20. The system of claim 16, wherein the disruption is selectable based on description of threats provided to the emulation engine.

21. The system of claim 16, wherein the disruption includes a plurality of disruptions configured to activate at selectable times and in a predetermined sequence.

22. A method for simulation of network flow in a first domain network based on emulation of disruption in a second domain network, the method comprising:
simulating, using a simulation engine, a network flow to generate a model of the first domain network, the network flow model based on a plurality of resources available in a first subject area corresponding to first domain network;
emulating, using an emulation engine, the second domain network, the second domain network having a plurality of resources available in a second subject area;
providing a disruption to the emulation engine, the disruption corresponding to at least one resource in the second domain network, the emulation engine utilizing the disruption to model the network flow of the resources in the second domain network;
reflecting, in the network flow model of the first domain network, the disruption in the second domain network, and
outputting, using an output engine, a representation of the network flow through the first domain network as a result of the disruption in the second domain network.

23. The method of claim 22, wherein the first domain network is a transportation domain and the second domain network is a cyber or cyber-physical domain.

24. The method of claim 22, wherein the simulation engine models network flow of a plurality of commodities in the first domain network.

25. The method of claim 22, further including creating, using a user interface, the network flow model of the first domain network.

26. The method of claim 22, further including providing to the emulation engine, a selected disruption based on a description of threats.

27. The method of claim 22, further providing a plurality of disruptions to the emulation engine, and assigning selected disruptions to activate at selectable times and in a predetermined sequence.
